(19) United States
(12) Patent Application Publication
(10) Pub. No.: US 2025/0317707 A1
(43) Pub. Date: Oct. 9, 2025

(54) SL POSITIONING SESSION CONTINUITY WITH SL RELAY UE HANDOVER

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 18/865,287

(22) PCT Filed: Jul. 12, 2023
(86) PCT No.: PCT/US2023/027557

§ 371 Date: Nov. 12, 2024

(30) Foreign Application Priority Data
Jul. 26, 2022 (GR) 20220100601

(51) Int. Cl. H04W 4/02; H04W 36/32

(52) U.S. Cl. CPC H04W 4/025; H04W 36/322

(57) ABSTRACT

Aspects presented herein relate to methods and devices for wireless communication including an apparatus, e.g., a UE or a network entity. The apparatus may participate in a positioning session with a network entity via a first relay UE during a handover from the first relay UE to a second relay UE, wherein the positioning session with the network entity via the first relay UE is associated with a first positioning configuration. The apparatus may also switch to a second positioning configuration if the first positioning configuration is not valid based on the handover or maintaining the first positioning configuration if the first positioning configuration is valid based on the handover.

### CROSS-REFERENCE TO RELATED APPLICATION

This application claims the benefit of Greece Patent Application Serial No. 20220100601, entitled “SL POSITIONING SESSION CONTINUITY WITH SL RELAY UE HANDOVER” and filed on Jul. 26, 2022, which is expressly incorporated by reference herein in its entirety.

### TECHNICAL FIELD

The present disclosure relates generally to communication systems, and more particularly, to sensing handover in wireless communication systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be an apparatus for wireless communication at a first user equipment (UE). The apparatus may participate in a positioning session with a network entity via a first relay UE during a handover from the first relay UE to a second relay UE, where the positioning session with the network entity via the first relay UE is associated with a first positioning configuration. The apparatus may also identify whether the first positioning configuration is valid based on the handover from the first relay UE to the second relay UE. The apparatus may also receive the second positioning configuration from the network entity if the first positioning configuration is not valid based on the handover. Further, the apparatus may transmit a positioning error message if the first positioning configuration is not valid based on the handover. The apparatus may also switch to a second positioning configuration if the first positioning configuration is not valid based on the handover or maintain the first positioning configuration if the first positioning configuration is valid based on the handover. The apparatus may also adjust a measurement period for the positioning session after switching to the second positioning configuration; or restart the measurement period for the positioning session after maintaining the first positioning configuration. Moreover, the apparatus may perform at least one positioning measurement for the positioning session via the first relay UE if the first positioning configuration is valid based on the handover; and transmit positioning measurement data for the positioning session via the second relay UE if the first positioning configuration is valid based on the handover, where the positioning measurement data is based on the at least one positioning measurement for the positioning session via the first relay UE.

In an aspect of the disclosure, a method, a computer-readable medium, and an apparatus are provided. The apparatus may be an apparatus for wireless communication at a network entity. The apparatus may participate in a positioning session with a first user equipment (UE) via a first relay UE during a handover from the first relay UE to a second relay UE, where the positioning session with the first UE via the first relay UE is associated with a first positioning configuration. The apparatus may also identify whether the first positioning configuration is valid based on the handover from the first relay UE to the second relay UE. The apparatus may also transmit the second positioning configuration for the first UE if the first positioning configuration is not valid based on the handover. Further, the apparatus may receive a positioning error message if the first positioning configuration is not valid based on the handover. The apparatus may also switch to a second positioning configuration if the first positioning configuration is not valid based on the handover or maintaining the first positioning configuration if the first positioning configuration is valid based on the handover. The apparatus may also adjust a measurement period for the positioning session after switching to the second positioning configuration; or restart the measurement period for the positioning session after maintaining the first positioning configuration. Moreover, the apparatus may receive positioning measurement data for the positioning session via the second relay UE if the first positioning configuration is valid based on the handover, where the positioning measurement data is based on at least one positioning measurement for the positioning session via the first relay UE.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5A is a diagram illustrating an example of positioning.

FIG. 5B is a diagram illustrating an example of positioning.

FIG. 5C is a diagram illustrating an example of positioning.

FIG. 6 is a diagram illustrating an example of a wireless communication system utilizing relay UEs and remote UEs.

FIG. 7 is a diagram illustrating example communications between transmission-reception point (TRP), relay UEs, and remote UEs.

FIG. 8 is a diagram illustrating example communications between TRP, relay UEs, and remote UEs.

FIG. 9 is a diagram illustrating example communications between TRP, relay UEs, and remote UEs.

FIG. 10 is a diagram illustrating examples of a minimum distance threshold and a maximum distance threshold for relay UE in a wireless communication system.

FIG. 11 is a diagram illustrating an example of a wireless communication system utilizing relay UEs and remote UEs.

FIG. 12 is a communication flow diagram illustrating example communications between UE and a network entity.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a diagram illustrating an example of a hardware implementation for an example apparatus and/or network entity.

FIG. 18 is a diagram illustrating an example of a hardware implementation for an example network entity.

FIG. 19 is a diagram illustrating an example of a hardware implementation for an example network entity.

### DETAILED DESCRIPTION

In some aspects of wireless communication, when UE-UTRAN (Uu) radio link failure (RLF) is detected by a relay UE or the relay UE performs a handover (HO) to another base station, the relay UE may send a message (e.g., a PC5-S message) to its connected remote UE(s) and the message may trigger relay reselection. Also, other types of indications/messages may be used for notification and a message (e.g., a PC5-RRC message) may be used for sending an indication to the remote UE upon Uu RLF at the relay UE or when the relay UE performs the handover. In some instances, when an idle/inactive relay UE performs cell selection/reselection, the relay UE may send an indication/message to its connected remote UE(s) which may trigger relay reselection. Additionally, certain messages (e.g., PC5-RRC messages) may be used to inform the remote UE when the relay UE performs cell selection/reselection. The relay UE may also send an indication/message (e.g., NotificationMessageSide link message) to its connected remote UE. When a relay UE detects a Uu RLF or the relay UE performs a handover to another base station or the relay UE performs cell selection/reselection, the relay UE may notify its connected remote UE(s) through a certain indication/message (e.g., a NotificationMessageSidelink message). If the remote UE (e.g., a remote UE in an RRC idle/inactive state) receives this message, it may perform relay selection/reselection. Also, if a remote UE (e.g., a remote UE in an RRC connected state) receives this message, it may perform the connection re-establishment. Some aspects of wireless communication may utilize a handover optimization procedure. In some instances, if a relay UE may not be able to support all active connectivity services (i.e., protocol data unit (PDU) sessions), a base station may need to know which PDU sessions should be switched to a target relay UE when preparing the path switch message. In these instances, aspects of wireless communication may not pursue optimization on a per-PDU-session. A remote UE may stop a user plane (UP) and control plane (CP) transmission via a relay link after reception of an RRC reconfiguration message from a base station. Also, for a layer 2 (L2) relay, the relay UE may initiate the PC5 unicast link bearer release (e.g., PC5-S), and the timing to execute the link release may be determined via UE implementation. In this case, when a remote UE considers that the bearer (e.g., from relay to remote) can be released, the remote UE may stop receiving the downlink data from the base station via the relay. In some instances, the handling of the RLC channel at the receive (Rx) side may be up to the PC5-RRC configuration (e.g., an RRCReconfigurationSidelink message/parameter) from the transmit (Tx) side. The remote UE may stop receiving the downlink data forwarded by relay UE upon the reception of PC5-RRC signaling (e.g., RRCReconfigurationSide link message/parameter) from the relay UE that may release the bearer. This handover optimization may force a relay UE or base station to drop the positioning session, such as if other high priority data PDU sessions are ongoing. In some aspects, as part of a relay-to-relay handover or reselection, some of the sidelink positioning configurations may change. That is, remote UEs and relays UEs may need to switch operating on different configurations (e.g., PC5 configurations). For example, UEs may be performing handover/reselection to obtain improved data on a Uu link. Also, certain types of links (e.g., a PC5 link) may be a good link for multiple relay UEs. Aspects of the present disclosure may determine how to handle a positioning session in case of a relay handover. In some instances, aspects presented herein may determine how to handle relay-to-relay handover or reselection, such as when some of the sidelink positioning configurations may change. For instance, as part of a remote UE handover or reelection process, some configurations may be reset and a UE may need to operate with a new configuration. In one embodiment, aspects presented herein may handle positioning sessions as part of a relay-to-relay handover or reelection. For example, maintaining session continuity after handover (e.g., by storing a positioning configuration message rather than discarding the message) may improve the latency of a UE positioning session. Further, aspects presented herein may distinguish between when a relay UE is merely relaying or the relay UE is acting as a positioning anchor UE.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

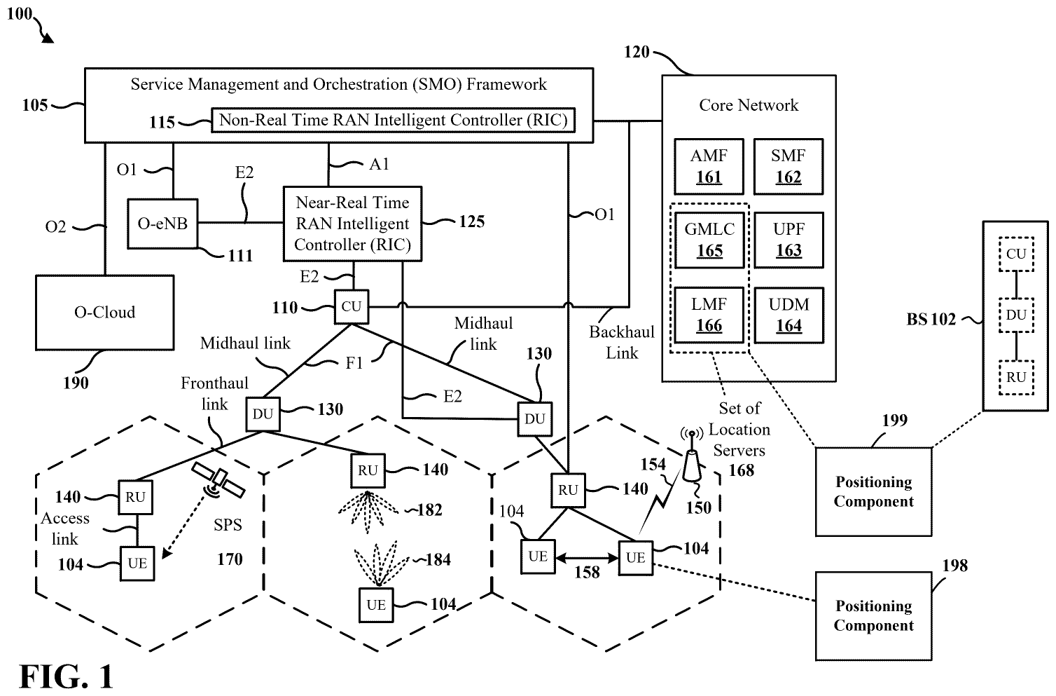

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a positioning component 198 that may be configured to participate in a positioning session with a network entity via a first relay UE during a handover from the first relay UE to a second relay UE, where the positioning session with the network entity via the first relay UE is associated with a first positioning configuration. Positioning component 198 may also be configured to identify whether the first positioning configuration is valid based on the handover from the first relay UE to the second relay UE. Positioning component 198 may also be configured to receive the second positioning configuration from the network entity if the first positioning configuration is not valid based on the handover. Positioning component 198 may also be configured to transmit a positioning error message if the first positioning configuration is not valid based on the handover. Positioning component 198 may also be configured to switch to a second positioning configuration if the first positioning configuration is not valid based on the handover or maintain the first positioning configuration if the first positioning configuration is valid based on the handover. Positioning component 198 may also be configured to adjust a measurement period for the positioning session after switching to the second positioning configuration; or restart the measurement period for the positioning session after maintaining the first positioning configuration. Positioning component 198 may also be configured to perform at least one positioning measurement for the positioning session via the first relay UE if the first positioning configuration is valid based on the handover; and transmit positioning measurement data for the positioning session via the second relay UE if the first positioning configuration is valid based on the handover, where the positioning measurement data is based on the at least one positioning measurement for the positioning session via the first relay UE.

In certain aspects, the base station 102 or LMF 166 may include a positioning component 199 that may be configured to participate in a positioning session with a first user equipment (UE) via a first relay UE during a handover from the first relay UE to a second relay UE, where the positioning session with the first UE via the first relay UE is associated with a first positioning configuration. Positioning component 199 may also be configured to identify whether the first positioning configuration is valid based on the handover from the first relay UE to the second relay UE. Positioning component 199 may also be configured to transmit the second positioning configuration for the first UE if the first positioning configuration is not valid based on the handover. Positioning component 199 may also be configured to receive a positioning error message if the first positioning configuration is not valid based on the handover. Positioning component 199 may also be configured to switch to a second positioning configuration if the first positioning configuration is not valid based on the handover or maintaining the first positioning configuration if the first positioning configuration is valid based on the handover. Positioning component 199 may also be configured to adjust a measurement period for the positioning session after switching to the second positioning configuration; or restart the measurement period for the positioning session after maintaining the first positioning configuration. Positioning component 199 may also be configured to receive positioning measurement data for the positioning session via the second relay UE if the first positioning configuration is valid based on the handover, where the positioning measurement data is based on at least one positioning measurement for the positioning session via the first relay UE. Although the following description may be focused on 5G NR, the concepts described herein may be applicable to other similar areas, such as LTE, LTE-A, CDMA, GSM, and other wireless technologies.

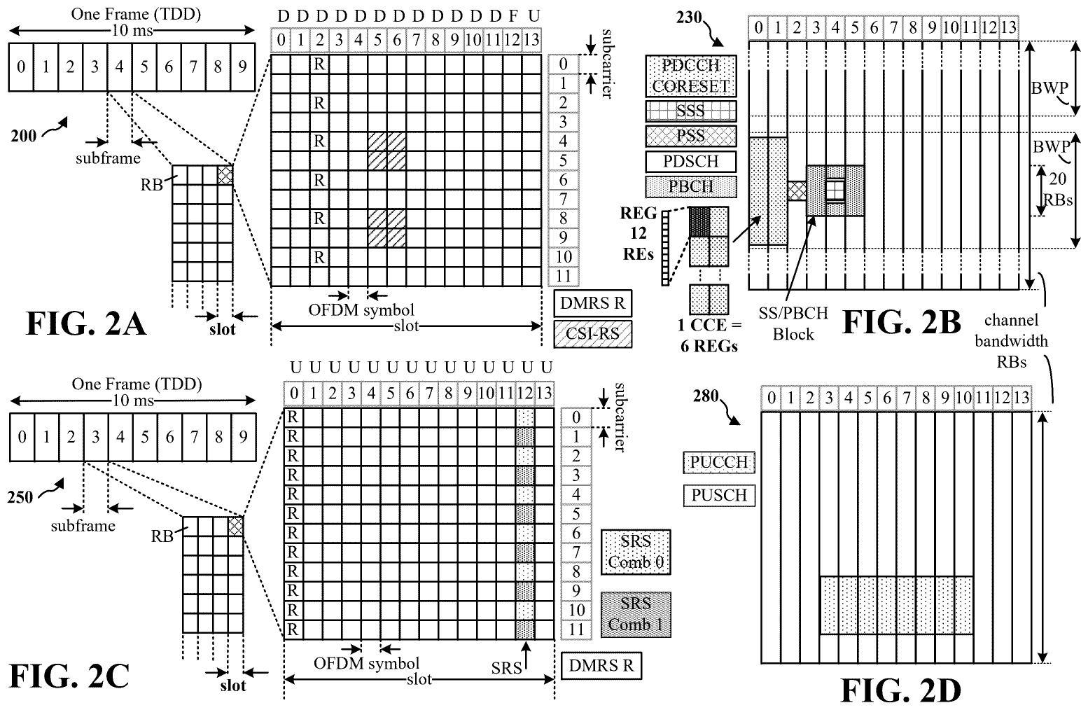

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

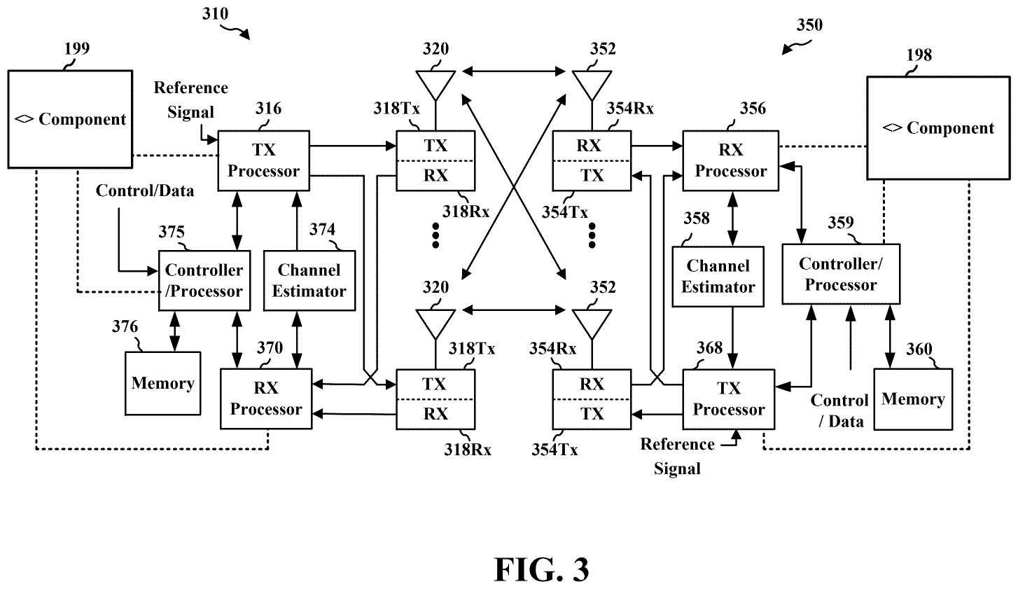

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression 1 decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the positioning component 198 of FIG. 1. At least one of the TX processor 316, the RX processor 370, and the controller/processor 375 may be configured to perform aspects in connection with the positioning component 199 of FIG. 1.

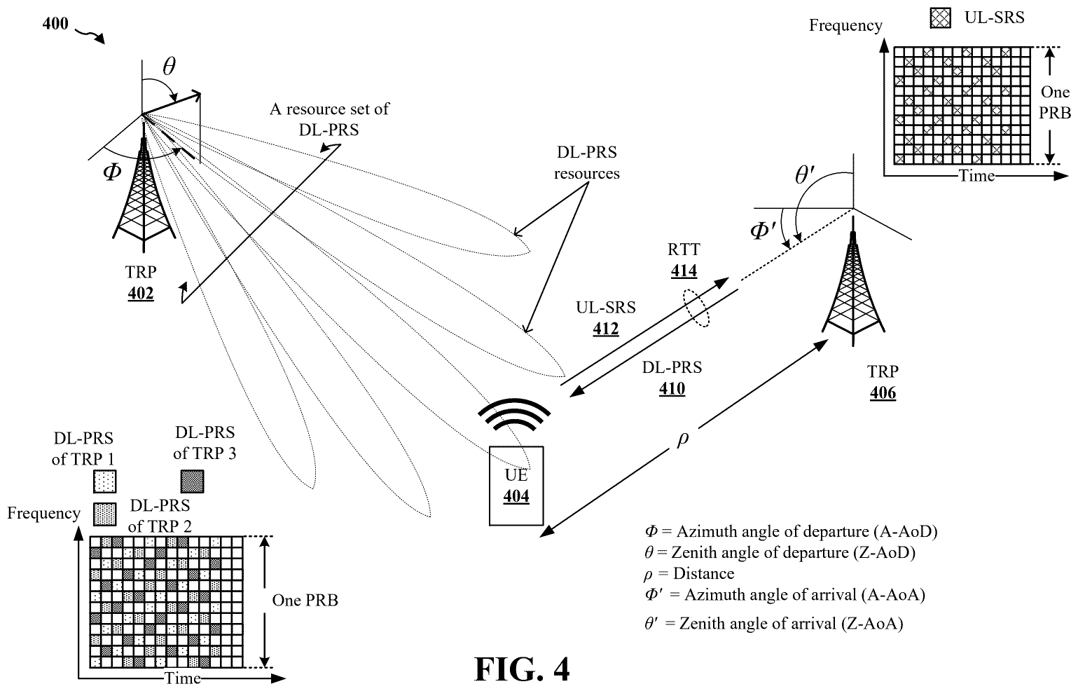

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time TPRS TX. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}|. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

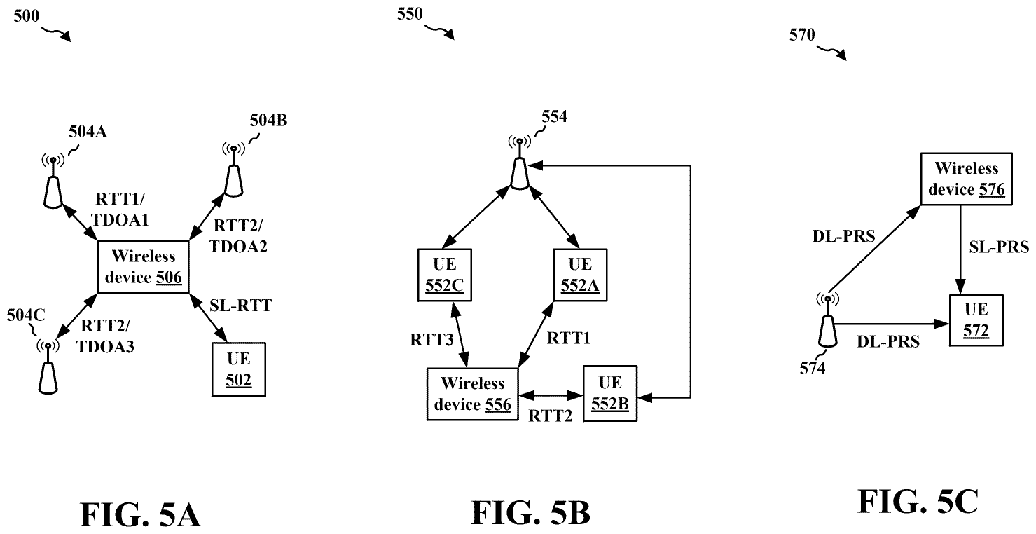

Aspects of wireless communication may utilize positioning that is based on sidelink between UEs, access link between network entity and UE, or based jointly on access link and sidelink. FIG. 5A is a diagram 500 illustrating an example of positioning. As illustrated in FIG. 5A, for positioning related to a wireless device 506, a first network entity 504A, a second network entity 504B, and a third network entity 504C may be involved and may each be associated with a respective RTT or TDOA that may be measured. To further improve accuracy of position related to the wireless device 506, a UE 502 (that may be associated with a location known to the network) may serve as an extra anchor for the positioning of the wireless device 506. A sidelink RTT between the UE 502 and the wireless device 506 may be measured. In the diagram 500, sidelink positioning and access link positioning may be used jointly.

FIG. 5B is a diagram 550 illustrating an example of positioning. As illustrated in FIG. 5B, for positioning related to a wireless device 556, a first UE 552A, a second UE 552B, and a third UE 552C may be involved and may each be associated with a respective RTT that may be measured. In the diagram 550, sidelink positioning may be used. Each of the first UE 552A, the second UE 552B, and the third UE 552C may be in communication with a network entity 554. FIG. 5C is a diagram 570 illustrating an example of positioning. As illustrated in FIG. 5C, for positioning of a UE 572, a network entity 574 may transmit PRS to the UE 572. If the PRS cannot be directly transmitted from the network entity 574 to the UE 572 (such as when the UE 572 is out of coverage), the network entity 574 may transmit the PRS to a wireless device 576 and the wireless device 576 may relay the PRS to the UE 572.

Sidelink communication may include direct wireless communication between a first device (e.g., a first UE or other sidelink device) and a second device (e.g., a second UE or other sidelink device), e.g., without being routed by a base station. In a first mode, a UE may receive a resource allocation for sidelink communication from the base station. The sidelink resource allocation from a base station may be referred to as “resource allocation mode 1” or a “centralized” resource allocation mode, e.g., in which a network entity allocates sidelink resources for multiple sidelink devices. Before exchanging communication, sidelink devices may perform a discovery procedure to discover each other. In some wireless communication systems, such as for communication systems supporting mode 2 resource allocation, the discovery procedure may include a first UE (that may be referred to as an announcing UE) that broadcasts the announcement message that is received by a second UE (that may be referred to as a monitoring UE). The discovery procedure, in which the announcing UE broadcasts an announcement message to one or more monitoring UEs, may be referred as mode A sidelink discovery. In another type of discovery procedure, a first UE (that may be referred to as a discoverer UE) sends a solicitation message including a discovery request and a second UE (that may be referred to as a discoveree UE) may receive the request and send a response message. The discovery procedure, in which the discoverer UE transmits a solicitation message including a discovery request to one or more discoveree UEs, may be referred as mode B sidelink discovery.

In some aspects of wireless communication, when UE-UTRAN (Uu) radio link failure (RLF) is detected by a relay UE or the relay UE performs a handover (HO) to another base station, the relay UE may send a message (e.g., a PC5-S message) to its connected remote UE(s) and the message may trigger relay reselection. Also, other types of indications/messages may be used for notification and a message (e.g., a PC5-RRC message) may be used for sending an indication to the remote UE upon Uu RLF at the relay UE or when the relay UE performs the handover. In some instances, when an idle/inactive relay UE performs cell selection/reselection, the relay UE may send an indication/message to its connected remote UE(s) which may trigger relay reselection. Additionally, certain messages (e.g., PC5-RRC messages) may be used to inform the remote UE when the relay UE performs cell selection/reselection. The relay UE may also send an indication/message (e.g., NotificationMessageSide link message) to its connected remote UE. When a relay UE detects a Uu RLF or the relay UE performs a handover to another base station or the relay UE performs cell selection/reselection, the relay UE may notify its connected remote UE(s) through a certain indication/message (e.g., a NotificationMessageSidelink message). If the remote UE (e.g., a remote UE in an RRC idle/inactive state) receives this message, it may perform relay selection/reselection. Also, if a remote UE (e.g., a remote UE in an RRC connected state) receives this message, it may perform the connection re-establishment.

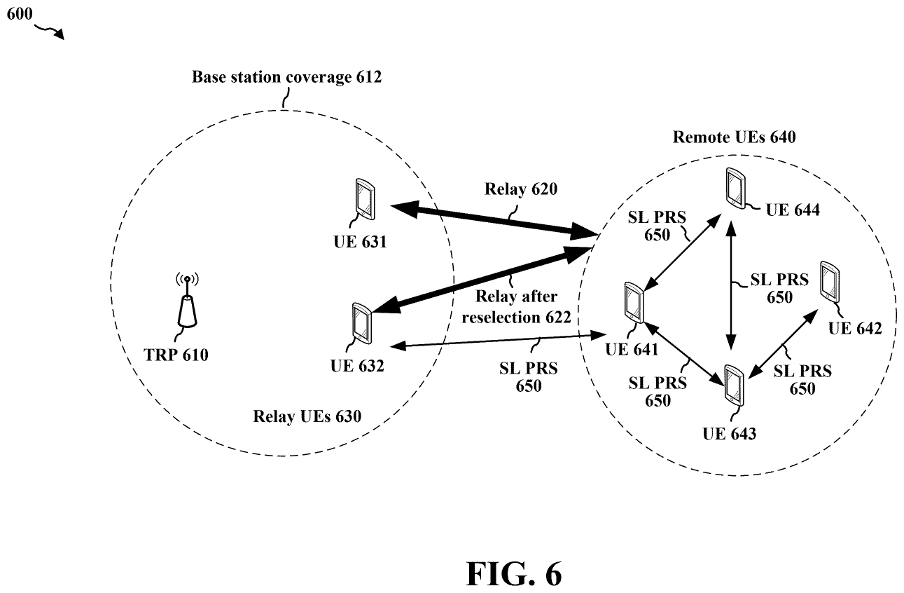

FIG. 6 illustrates diagram 600 including an example of a wireless communication system. More specifically, diagram 600 in FIG. 6 shows an example of a wireless communication system utilizing a transmission-reception point (TRP) (e.g., TRP 610), relay UEs 630 (e.g., UE 631 and UE 632) and remote UEs 640 (e.g., UE 641, UE 642, UE 643, and UE 644). As shown in FIG. 6, diagram 600 includes TRP 610 in base station coverage 612, as well as a relay 620 between relay UEs 630 and remote UEs 640, and a relay after reselection 622 between relay UEs 630 and remote UEs 640. For instance, diagram 600 shows that TRP 610 is in the coverage of UE 631, which is in connected mode (e.g., RRC connected mode). Also, remote UEs 640 (e.g., UE 641, UE 642, UE 643, and UE 644) are out of coverage with respect to TRP 610. The remote UEs 640 (e.g., UE 641, UE 642, UE 643, and UE 644) may be connected to the relay UE 631 through PC5 links. Remote UEs 640 (e.g., UE 641, UE 642, UE 643, and UE 644) may also transmit SL PRS 650. UE 631 may continue informing other UEs regarding the health of its Uu link to the remote UEs 640 (e.g., via a NotificationMessageSidelink message). The remote UEs 640 may need to perform a relay reselection (e.g., in RRC inactive and idle mode) and connection reestablishment (e.g., in RRC connected state). If one of the remote UEs 640 determines the relay UE 632 corresponds to a better coverage, all of the remote UEs 640 may switch to relay UE 632. As part of a UE 631 to UE 632 remote UE handover/reelection process, a previous configuration may be reset and the UEs may need to operate on a newly defined configuration.

Some aspects of wireless communication may utilize a handover optimization procedure. In some instances, if a relay UE may not be able to support all active connectivity services (i.e., protocol data unit (PDU) sessions), a base station may need to know which PDU sessions should be switched to a target relay UE when preparing the path switch message. In these instances, aspects of wireless communication may not pursue optimization on a per-PDU-session. A remote UE may stop a user plane (UP) and control plane (CP) transmission via a relay link after reception of an RRC reconfiguration message from a base station. Also, for a layer 2 (L2) relay, the relay UE may initiate the PC5 unicast link bearer release (e.g., PC5-S), and the timing to execute the link release may be determined via UE implementation. In this case, when a remote UE considers that the bearer (e.g., from relay to remote) can be released, the remote UE may stop receiving the downlink data from the base station via the relay. In some instances, the handling of the RLC channel at the receive (Rx) side may be up to the PC5-RRC configuration (e.g., an RRCReconfigurationSide link message/parameter) from the transmit (Tx) side. The remote UE may stop receiving the downlink data forwarded by relay UE upon the reception of PC5-RRC signaling (e.g., RRCReconfigurationSidelink message/parameter) from the relay UE that may release the bearer. This handover optimization may force a relay UE or base station to drop the positioning session, such as if other high priority data PDU sessions are ongoing.

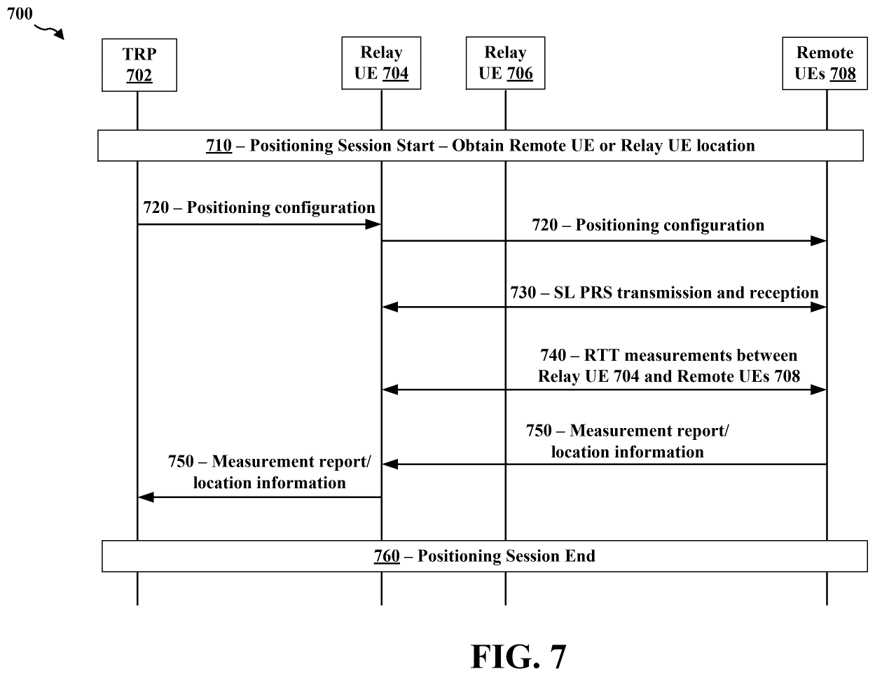

FIG. 7 illustrates diagram 700 including example communications in a wireless communication system. More specifically, diagram 700 in FIG. 7 shows example communications between a TRP (e.g., TRP 702) and remote UEs (e.g., remote UEs 708) via relay UEs (e.g., relay UE 704 and relay UE 706). As shown in FIG. 7, at 710, TRP 702 and remote UEs 708 may start the positioning session, such as to obtain a location of a remote UE or a relay UE. At 720, TRP 702 may transmit a positioning configuration to relay UE 704, and relay UE 704 may forward the positioning configuration to remote UEs 708. At 730, remote UEs 708 and relay UE 704 may transmit and/or receive sidelink (SL) positioning reference signals (PRS). Also, at 740, remote UEs 708 and relay UE 704 may perform round trip time (RTT) measurements. At 750, remote UEs 708 may transmit a measurement report and/or location information to relay UE 704, and relay UE 704 may forward the measurement report and/or location information to TRP 702. At 760, the positioning session may end.

In some aspects, as part of a relay-to-relay handover or reselection, some of the sidelink positioning configurations may change. That is, remote UEs and relays UEs may need to switch operating on different configurations (e.g., PC5 configurations). For example, UEs may be performing handover/reselection to obtain improved data on a Uu link. Also, certain types of links (e.g., a PC5 link) may be a good link for multiple relay UEs. Based on the above, it may be beneficial to determine how to handle the positioning session in case of a relay handover. For instance, it may be beneficial to determine how to handle relay-to-relay handover or reselection, such as when some of the sidelink positioning configurations may change.

Aspects of the present disclosure may determine how to handle a positioning session in case of a relay handover. In some instances, aspects presented herein may determine how to handle relay-to-relay handover or reselection, such as when some of the sidelink positioning configurations may change. For instance, as part of a remote UE handover or reelection process, some configurations may be reset and a UE may need to operate with a new configuration. In one embodiment, aspects presented herein may handle positioning sessions as part of a relay-to-relay handover or reelection. For example, maintaining session continuity after handover (e.g., by storing a positioning configuration message rather than discarding the message) may improve the latency of a UE positioning session. Further, aspects presented herein may distinguish between when a relay UE is merely relaying or the relay UE is acting as a positioning anchor UE.

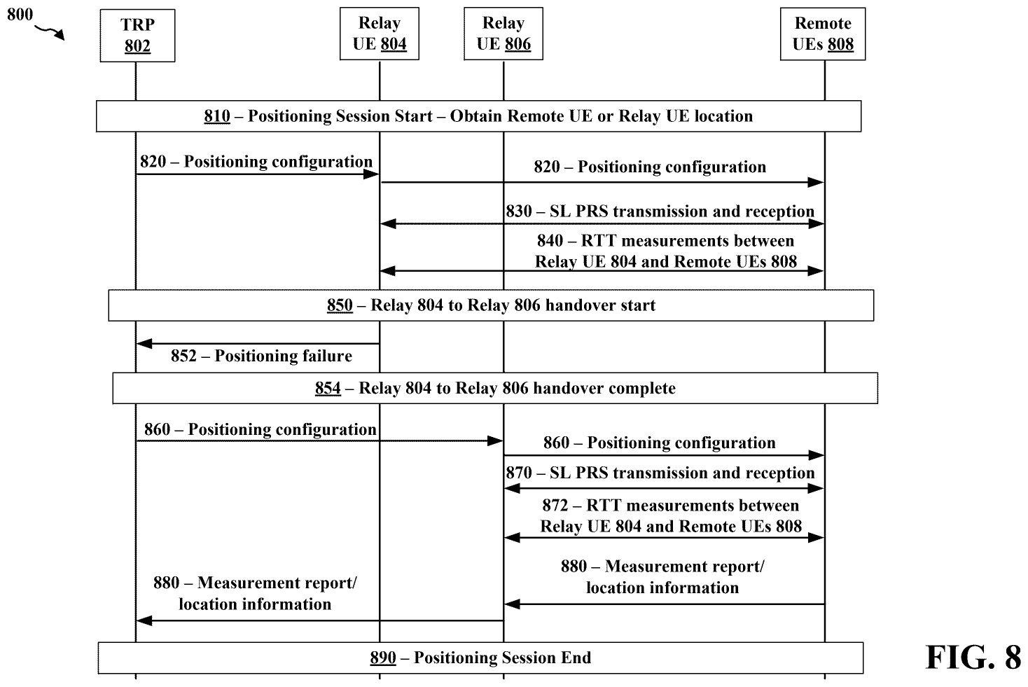

FIG. 8 illustrates diagram 800 including example communications in a wireless communication system. More specifically, diagram 800 in FIG. 8 shows example communications between a TRP (e.g., TRP 802) and remote UEs (e.g., remote UEs 808) via relay UEs (e.g., relay UE 804 and relay UE 806). As shown in FIG. 8, at 810, TRP 802 and remote UEs 808 may start the positioning session, such as to obtain a location of a remote UE or a relay UE. As 820, TRP 802 may transmit a positioning configuration to relay UE 804, and relay UE 804 may forward the positioning configuration to remote UEs 808. At 830, remote UEs 808 and relay UE 804 may transmit and/or receive sidelink (SL) positioning reference signals (PRS). Also, at 840, remote UEs 808 and relay UE 804 may perform round trip time (RTT) measurements. At 850, relay UE 804 and relay UE 806 may start a handover process. At 852, if there is a positioning failure, relay UE 804 may transmit a positioning failure message to the TRP 802. At 854, relay UE 804 and relay UE 806 may end the handover process. At 860, TRP 802 may transmit a positioning configuration to relay UE 806, and relay UE 806 may forward the positioning configuration to remote UEs 808. At 870, remote UEs 808 and relay UE 806 may transmit and/or receive SL PRS. Also, at 872, remote UEs 808 and relay UE 806 may perform RTT measurements. At 880, remote UEs 808 may transmit a measurement report and/or location information to relay UE 806, and relay UE 806 may forward the measurement report and/or location information to TRP 802. At 890, the positioning session may end.

As depicted in FIG. 8, aspects presented herein may provide solutions for handling a remote/relay UE handover with positioning sessions. As shown at 860, a new positioning session may start after the handover to relay UE 806 with an updated positioning configuration. Also, both measurement and data transfer may be occurring through the new relay UE 806 after the handover. That is, there may be a way for a UE to hold the new positioning measurement from the relay UE 804 after a positioning session. This may have an impact on (i.e., improve) the overall latency of the positioning session. As shown at 852, the relay UE 804, or the remote UEs 808, may send a positioning error message with a corresponding description (e.g., an error due to relay UE connectivity/reselection message).

In some aspects, in a certain mode (e.g., mode 1), positioning configurations may be transferred to the relay UE, as well as the remote UEs, through a message (e.g., an RRC configuration message). During the handover, the UE may drop an RRC configuration message and wait for a new RRC configuration message from the network or SL UEs. Dropping the positioning configuration may have an impact on the positioning session latency (i.e., it may improve the positioning session latency). Aspects presented herein may store the positioning configuration message across the UE handover, re-selection, and/or cell selection. That is, aspects presented herein may not release a positioning configuration across relay UE handovers.

Aspects presented herein may also utilize a measurement period during a handover process between relay UEs. In one aspect, after a relay UE handover, the positioning configuration may continue. In this aspects, the positioning measurement may be extended to accommodate the handover latency or time. Additionally, after a relay UE handover, the positioning configuration may change or alter. For example, the positioning measurement may be restarted after the handover.

In some aspects, a relay UE may merely be relaying a positioning message. For instance, the relay UE may not be doing any modification and selection for a positioning configuration (e.g., the positioning configuration may be selected by a network entity, such as a TRP or LMF). The network entity (e.g., TRP or LMF) may use the same positioning configuration across the handover or reselection. Additionally, the positioning session may continue between the earlier UE and the remote UEs, but the positioning measurement data may need to be transferred though the newly selected relay UE after the handover. For instance, the positioning session may be divided into two parts: a positioning measurement and a positioning data transfer. The positioning measurement may still continue with respect to the older relay UE. The positioning data transfer may need to occur through a new handover relay UE. In another aspect, a relay UE may be acting as a relay, as well as a positioning anchor UE. Here, there may be multiple positioning configurations selected by the network entity (e.g., a TRP or LMF). Also, the anchor UE may select the positioning configuration for the positioning use case. In some instances, the old positioning anchor/relay UE may provide the positioning configuration to the new anchor UE or relay UE. By doing so, the anchor/relay UE may make sure a positioning session can continue after the relay handover.

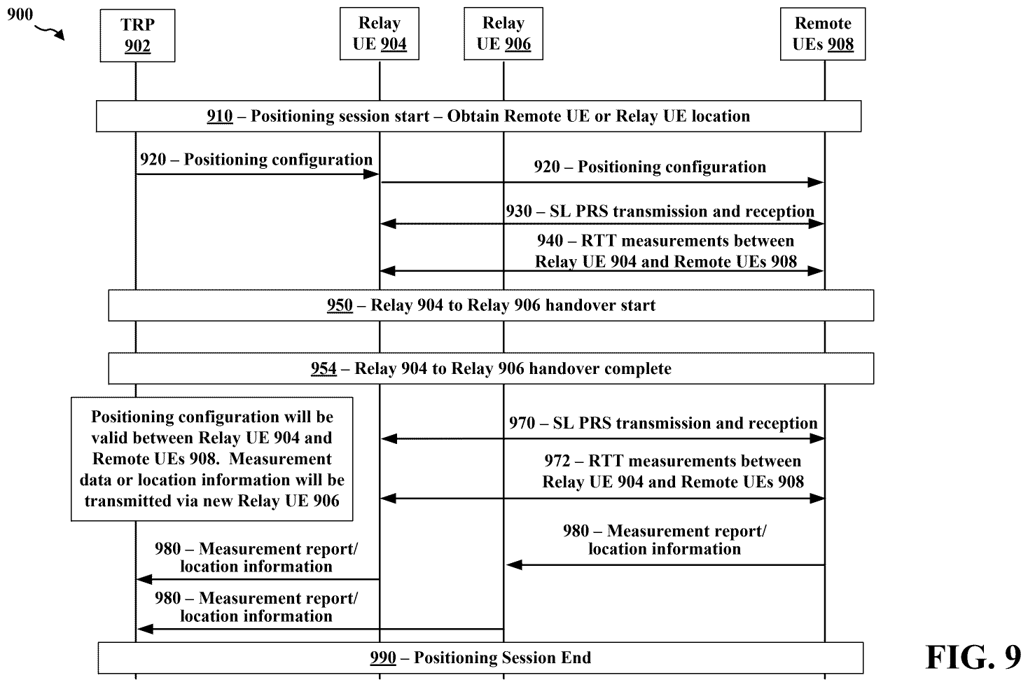

FIG. 9 illustrates diagram 900 including example communications in a wireless communication system. More specifically, diagram 900 in FIG. 9 shows example communications between a TRP (e.g., TRP 902) and remote UEs (e.g., remote UEs 908) via relay UEs (e.g., relay UE 904 and relay UE 906). As shown in FIG. 9, at 910, TRP 902 and remote UEs 908 may start the positioning session, such as to obtain a location of a remote UE or a relay UE. As 920, TRP 902 may transmit a positioning configuration to relay UE 904, and relay UE 904 may forward the positioning configuration to remote UEs 908. At 930, remote UEs 908 and relay UE 904 may transmit and/or receive sidelink (SL) positioning reference signals (PRS). Also, at 940, remote UEs 908 and relay UE 904 may perform round trip time (RTT) measurements. At 950, relay UE 904 and relay UE 906 may start a handover process. At 954, relay UE 904 and relay UE 906 may end the handover process. After the handover, the positioning configuration may remain valid between relay UE 904 and remote UEs 908. As such, measurement data or location information may be transmitted via new relay UE 906. That is, at 970, remote UEs 908 and relay UE 904 may transmit and/or receive SL PRS. Also, at 972, remote UEs 908 and relay UE 904 may perform RTT measurements. At 980, remote UEs 908 may transmit a measurement report and/or location information to relay UE 906, and relay UE 906 may forward the measurement report and/or location information to TRP 902. Also, at 980, relay UE 904 may forward the measurement report and/or location information to TRP 902 (i.e., relay UE 904 may have stored (or determined) the measurement report and/or location information for forwarding). At 990, the positioning session may end.

As depicted in FIG. 9, aspects presented herein may maintain a positioning session continuity after a handover. For instance, positioning anchor UEs and/or positioning configurations may be the same before and after a handover. Also, a measurement report and location information from one relay UE (e.g., relay UE 904) and remote UEs (e.g., remote UEs 908) may go through a new relay UE (e.g., relay UE 906). By doing so, this may improve the latency of the UE positioning session.

Additionally, aspects presented herein may utilize a new positioning-specific threshold for relay reselection. In some types of positioning sessions, solely the positioning session may occur between the relay and remote UEs. For instance, the relay UE may be mainly used for positioning, rather than data. Aspects presented herein may add a positioning threshold bias to an existing threshold in order to avoid a handover or cell change during the positioning session. For example, aspects presented herein may introduce extra bias for a positioning session in order to reduce the handover frequency (e.g., if solely the positioning session is occurring). In some instances, a positioning threshold bias may be utilized if just the positioning session is running between a relay UE and remote UEs.

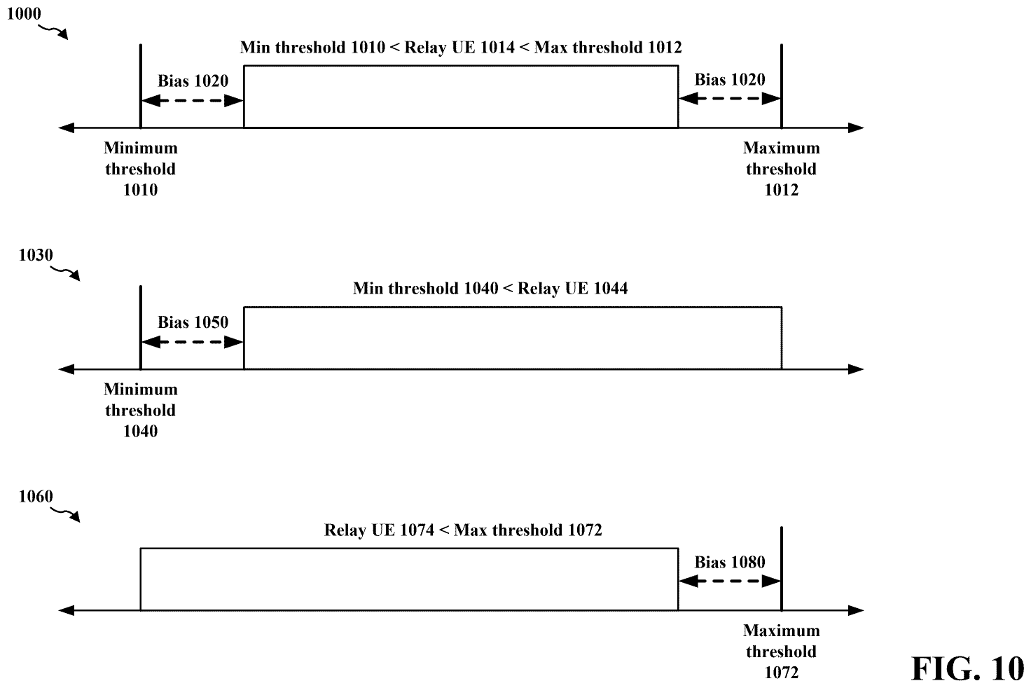

FIG. 10 includes diagram 1000, diagram 1030, and diagram 1060 illustrating examples of a minimum distance threshold and a maximum distance threshold for a relay UE in a wireless communication system. Diagram 1000 shows an example of a minimum distance threshold 1010 and a maximum distance threshold 1012 for relay UE 1014 in a wireless communication system. Also, diagram 1000 depicts bias 1020 with respect to the minimum distance threshold 1010 and a maximum distance threshold 1012. More specifically, bias 1020 is above the minimum distance threshold 1010 and below the maximum distance threshold 1012, such that the distance of the relay UE 1014 is greater than the minimum distance threshold 1010 and less than the maximum distance threshold 1012. Diagram 1030 shows an example of a minimum distance threshold 1040 for relay UE 1044 in a wireless communication system. Further, diagram 1030 depicts bias 1050 with respect to the minimum distance threshold 1040. More specifically, bias 1050 is above the minimum distance threshold 1040, such that the distance of the relay UE 1044 may be greater than the minimum distance threshold 1040. Diagram 1060 shows an example of a maximum distance threshold 1072 for relay UE 1074 in a wireless communication system. Additionally, diagram 1060 depicts bias 1080 with respect to a maximum distance threshold 1072. More specifically, bias 1080 is below the maximum distance threshold 1072, such that the distance of the relay UE 1074 is less than the maximum distance threshold 1072.

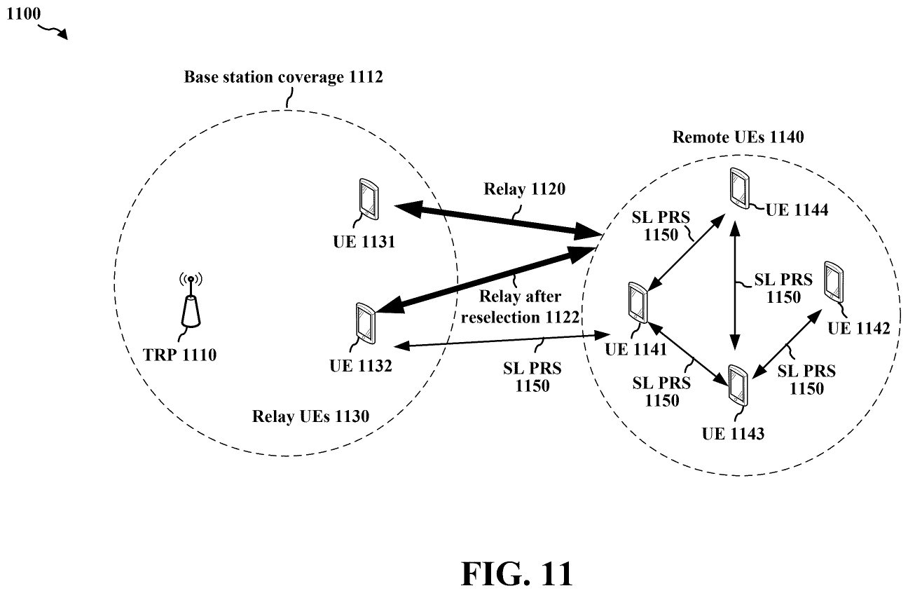

FIG. 11 illustrates diagram 1100 including an example of a wireless communication system. More specifically, diagram 1100 in FIG. 11 shows an example of a wireless communication system utilizing a transmission-reception point (TRP) (e.g., TRP 1110), relay UEs 1130 (e.g., UE 1131 and UE 1132) and remote UEs 1140 (e.g., UE 1141, UE 1142, UE 1143, and UE 1144). As shown in FIG. 11, diagram 1100 shows TRP 1110 in base station coverage 1112, as well as a relay 1120 between relay UEs 1130 and remote UEs 1140, and a relay after reselection 1122 between relay UEs 1130 and remote UEs 1140. For instance, diagram 1100 shows that TRP 1110 is in the coverage of UE 1131, which is in connected mode (e.g., RRC connected mode). Also, remote UEs 1140 (e.g., UE 1141, UE 1142, UE 1143, and UE 1144) may be out of coverage with respect to TRP 1110. The remote UEs 1140 (e.g., UE 1141, UE 1142, UE 1143, and UE 1144) may be connected to the relay UE 1131 through PC5 links. The remote UEs 1140 (e.g., UE 1141, UE 1142, UE 1143, and UE 1144) may transmit and/or receive SL PRS 1150. UE 1131 may continue informing other UEs regarding the health of its Uu link to the remote UEs 1140 (e.g., via a NotificationMessageSidelink message). The remote UEs 1140 may need to perform a relay reselection (e.g., in RRC inactive and idle mode) and connection reestablishment (e.g., in RRC connected state). If one of the remote UEs 1140 determines the relay UE 1132 corresponds to a better coverage, all of the remote UEs 1140 may switch to relay UE 1132. As part of a UE 1131 to UE 1132 remote UE handover/reelection process, a previous configuration may be reset and the UEs may need to operate on a newly defined configuration.

In some aspects, as depicted in FIG. 11, when the UE-UTRANS (Uu) reference signal received power (RSRP) of a relay UE is below a configured minimum threshold or above a configured maximum threshold, the relay UE may send an indication/message to its connected remote UE(s) which may trigger relay reselection or connection re-establishment. Also, a remote UE may be doing an increased amount of re-evaluation of the relay UEs and have a higher chance to move into an improved Uu coverage for the relay UE. As shown in FIG. 11, a relay UE (e.g., UE 1131 and UE 1132) may send a message (e.g., a NotificationMessageSidelink message) to the remote UEs 1140 (e.g., UE 1141, UE 1142, UE 1143, and UE 1144) may apply to the following: if the RRC idle/inactive state remote UE receives the message, it may perform relay selection/reselection for data, but with regard to positioning reference signal transmission/reception, no change is expected. Also, if the RRC connected state remote UE receives the message, it may perform a connection re-establishment for data, but with regard to positioning reference signal transmission/reception, no change is expected.

Aspects of the present disclosure may include a number of benefits or advantages. For instance, aspects presented herein may determine how to handle relay-to-relay handover or reselection, such as when some of the sidelink positioning configurations may change. Also, as part of a remote UE handover or reelection process, some configurations may be reset and a UE may need to operate with a new configuration. In one instance, aspects presented herein may handle positioning sessions as part of a relay-to-relay handover or reelection. For example, maintaining session continuity after a handover (e.g., by storing a positioning configuration message rather than discarding the message) may improve the latency of a UE positioning session. Further, aspects presented herein may distinguish between when a relay UE is merely relaying or the relay UE is acting as a positioning anchor UE.

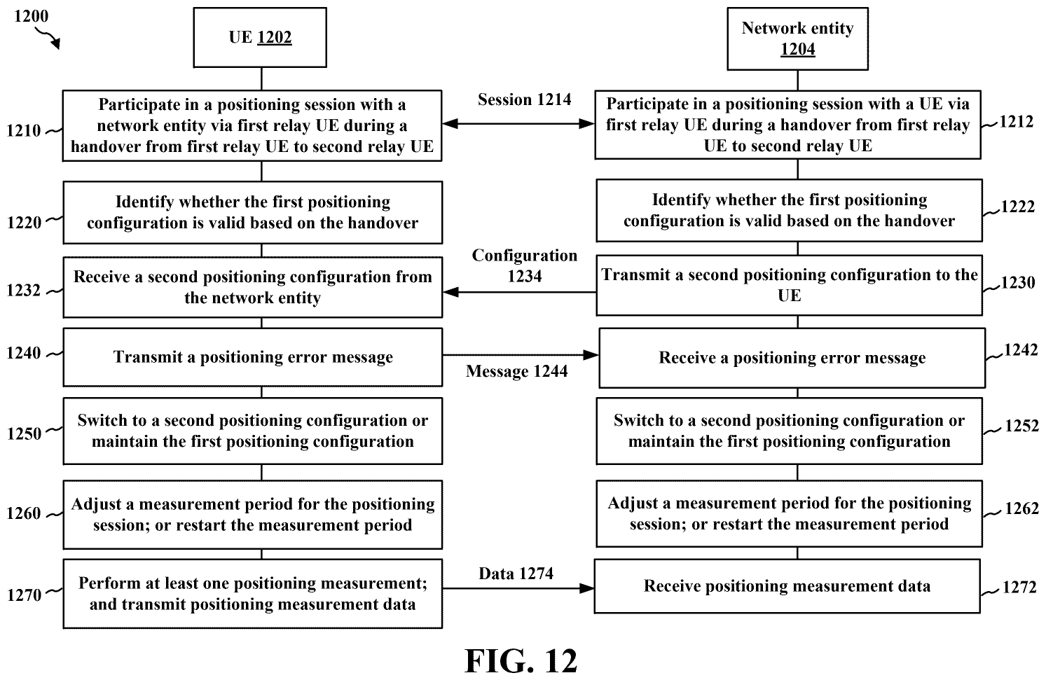

FIG. 12 is a communication flow diagram 1200 of wireless communication in accordance with one or more techniques of this disclosure. As shown in FIG. 12, diagram 1200 includes example communications between UE 1202 (e.g., a wireless device) and network entity 1204 (e.g., a TRP, LMF, or base station), in accordance with one or more techniques of this disclosure. In some aspects, UE 1202 may be a first wireless device and network entity 1204 may be a second wireless device.

At 1210, UE 1202 may participate in a positioning session (e.g., session 1214) with a network entity via a first relay UE during a handover from the first relay UE to a second relay UE, where the positioning session with the network entity via the first relay UE is associated with a first positioning configuration. The first positioning configuration may be associated with a first radio resource control (RRC) configuration message, and where the second positioning configuration is associated with a second RRC configuration message different from the first RRC configuration message.

At 1212, the network entity 1204 may participate in a positioning session (e.g., session 1214) with a first user equipment (UE) via a first relay UE during a handover from the first relay UE to a second relay UE, where the positioning session with the first UE via the first relay UE is associated with a first positioning configuration. The first positioning configuration may be associated with a first radio resource control (RRC) configuration message, and where the second positioning configuration is associated with a second RRC configuration message different from the first RRC configuration message.

At 1220, UE 1202 may identify whether the first positioning configuration is valid based on the handover from the first relay UE to the second relay UE.

At 1222, the network entity 1204 may identify whether the first positioning configuration is valid based on the handover from the first relay UE to the second relay UE.

At 1230, the network entity 1204 may transmit the second positioning configuration (e.g., configuration 1234) for the first UE if the first positioning configuration is not valid based on the handover.

At 1232, UE 1202 may receive the second positioning configuration (e.g., configuration 1234) from the network entity if the first positioning configuration is not valid based on the handover.

At 1240, UE 1202 may transmit a positioning error message (e.g., message 1244) if the first positioning configuration is not valid based on the handover.

At 1242, the network entity 1204 may receive a positioning error message (e.g., message 1244) if the first positioning configuration is not valid based on the handover.

At 1250, UE 1202 may switch to a second positioning configuration if the first positioning configuration is not valid based on the handover or maintain the first positioning configuration if the first positioning configuration is valid based on the handover. The second positioning configuration may be provided to the second relay UE if the first positioning configuration is not valid based on the handover.

At 1252, the network entity 1204 may switch to a second positioning configuration if the first positioning configuration is not valid based on the handover or maintaining the first positioning configuration if the first positioning configuration is valid based on the handover. The second positioning configuration may be provided to the second relay UE if the first positioning configuration is not valid based on the handover.

At 1260, UE 1202 may adjust a measurement period for the positioning session after switching to the second positioning configuration; or restart the measurement period for the positioning session after maintaining the first positioning configuration.

At 1262, the network entity 1204 may adjust a measurement period for the positioning session after switching to the second positioning configuration; or restart the measurement period for the positioning session after maintaining the first positioning configuration.

At 1270, UE 1202 may perform at least one positioning measurement for the positioning session via the first relay UE if the first positioning configuration is valid based on the handover; and transmit positioning measurement data (e.g., data 1274) for the positioning session via the second relay UE if the first positioning configuration is valid based on the handover, where the positioning measurement data is based on the at least one positioning measurement for the positioning session via the first relay UE. In some aspects, performing the at least one positioning measurement may include at least one of: performing a set of round trip time (RTT) measurements or transmitting at least one positioning reference signal (PRS) transmission. The positioning measurement data may include at least one of a measurement report or location information for the first UE.

At 1272, the network entity 1204 may receive positioning measurement data (e.g., data 1274) for the positioning session via the second relay UE if the first positioning configuration is valid based on the handover, where the positioning measurement data is based on at least one positioning measurement for the positioning session via the first relay UE. The at least one positioning measurement may be associated with at least one of a set of round trip time (RTT) measurements or a positioning reference signal (PRS) transmission. The positioning measurement data may include at least one of a measurement report or location information for the first UE.

In some aspects, the handover from the first relay UE to the second relay UE may be associated with at least one handover distance threshold, such that the handover is executed if a distance between the first UE and the first relay UE is greater than the at least one handover distance threshold, where the at least one handover distance threshold includes a threshold bias distance. The at least one handover distance threshold may include a minimum distance threshold and a maximum distance threshold, where the threshold bias distance is at least one of: (i) greater than the minimum distance threshold, (ii) less than the maximum distance threshold, or (iii) greater than the minimum distance threshold and less than the maximum distance threshold. The handover from the first relay UE to the second relay UE may be associated with a notification message from the first relay UE to the first UE, where the first UE initiates the handover if the first UE is in a radio resource control (RRC) idle state or an RRC inactive state, and where the first UE initiates a connection re-establishment if the first UE is in an RRC connected state. The second positioning configuration may be associated with the positioning session between the first UE and the network entity via the second relay UE. The positioning session may be a sidelink (SL) positioning session, where the handover from the first relay UE to the second relay UE is a SL handover, where the first UE is a first remote UE, and where the network entity is a transmission-reception point (TRP) or a location management function (LMF).

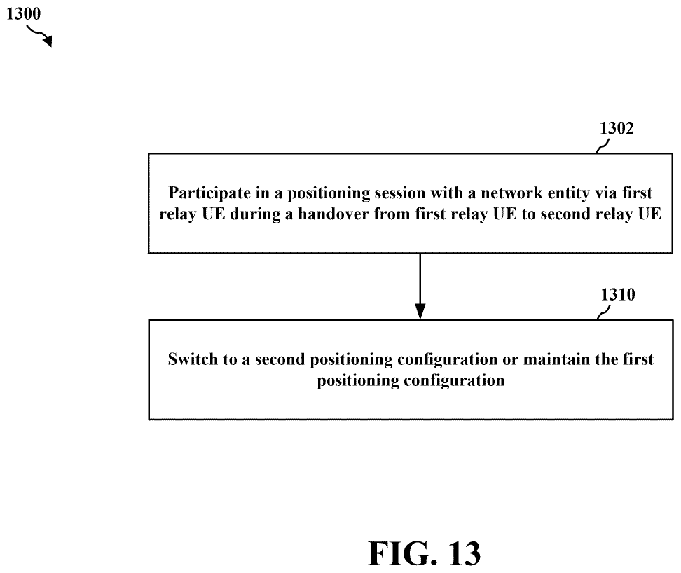

FIG. 13 is a flowchart 1300 of a method of wireless communication. The method may be performed by a UE or a first wireless device (e.g., the UE 104, UE 1202; the apparatus 1704). The methods described herein may provide a number of benefits, such as improving resource utilization and/or power savings.

At 1302, the UE may participate in a positioning session with a network entity via a first relay UE during a handover from the first relay UE to a second relay UE, where the positioning session with the network entity via the first relay UE is associated with a first positioning configuration, as discussed with respect to FIGS. 4-12. For example, as described in 1210 of FIG. 12, the UE 1202 may participate in a positioning session with a network entity via a first relay UE during a handover from the first relay UE to a second relay UE, where the positioning session with the network entity via the first relay UE is associated with a first positioning configuration. Further, step 1302 may be performed by positioning component 198. The first positioning configuration may be associated with a first radio resource control (RRC) configuration message, and where the second positioning configuration is associated with a second RRC configuration message different from the first RRC configuration message.

At 1310, the UE may switch to a second positioning configuration if the first positioning configuration is not valid based on the handover or maintain the first positioning configuration if the first positioning configuration is valid based on the handover, as discussed with respect to FIGS. 4-12. For example, as described in 1250 of FIG. 12, the UE 1202 may switch to a second positioning configuration if the first positioning configuration is not valid based on the handover or maintain the first positioning configuration if the first positioning configuration is valid based on the handover. Further, step 1310 may be performed by positioning component 198. The second positioning configuration may be provided to the second relay UE if the first positioning configuration is not valid based on the handover.

In some aspects, the handover from the first relay UE to the second relay UE may be associated with at least one handover distance threshold, such that the handover is executed if a distance between the first UE and the first relay UE is greater than the at least one handover distance threshold, where the at least one handover distance threshold includes a threshold bias distance. The at least one handover distance threshold may include a minimum distance threshold and a maximum distance threshold, where the threshold bias distance is at least one of: (i) greater than the minimum distance threshold, (ii) less than the maximum distance threshold, or (iii) greater than the minimum distance threshold and less than the maximum distance threshold. The handover from the first relay UE to the second relay UE may be associated with a notification message from the first relay UE to the first UE, where the first UE initiates the handover if the first UE is in a radio resource control (RRC) idle state or an RRC inactive state, and where the first UE initiates a connection re-establishment if the first UE is in an RRC connected state. The second positioning configuration may be associated with the positioning session between the first UE and the network entity via the second relay UE. The positioning session may be a sidelink (SL) positioning session, where the handover from the first relay UE to the second relay UE is a SL handover, where the first UE is a first remote UE, and where the network entity is a transmission-reception point (TRP) or a location management function (LMF).

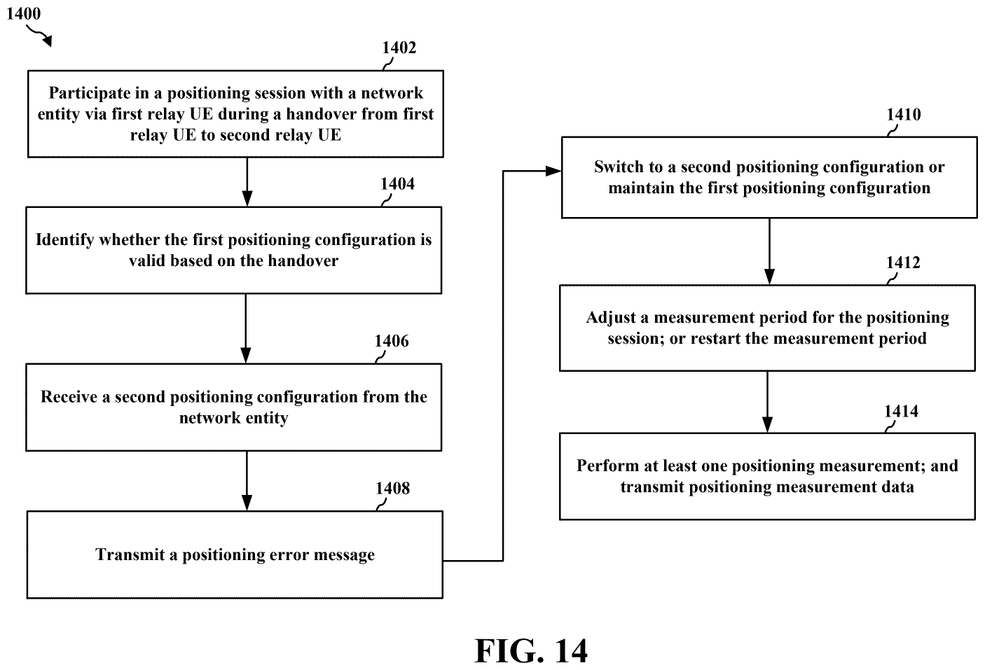

FIG. 14 is a flowchart 1400 of a method of wireless communication. The method may be performed by a UE or a first wireless device (e.g., the UE 104, UE 1202; the apparatus 1704). The methods described herein may provide a number of benefits, such as improving resource utilization and/or power savings.

At 1402, the UE may participate in a positioning session with a network entity via a first relay UE during a handover from the first relay UE to a second relay UE, where the positioning session with the network entity via the first relay UE is associated with a first positioning configuration, as discussed with respect to FIGS. 4-12. For example, as described in 1210 of FIG. 12, the UE 1202 may participate in a positioning session with a network entity via a first relay UE during a handover from the first relay UE to a second relay UE, where the positioning session with the network entity via the first relay UE is associated with a first positioning configuration. Further, step 1402 may be performed by positioning component 198. The first positioning configuration may be associated with a first radio resource control (RRC) configuration message, and where the second positioning configuration is associated with a second RRC configuration message different from the first RRC configuration message.

At 1404, the UE may identify whether the first positioning configuration is valid based on the handover from the first relay UE to the second relay UE, as discussed with respect to FIGS. 4-12. For example, as described in 1220 of FIG. 12, the UE 1202 may identify whether the first positioning configuration is valid based on the handover from the first relay UE to the second relay UE. Further, step 1404 may be performed by positioning component 198.

At 1406, the UE may receive the second positioning configuration from the network entity if the first positioning configuration is not valid based on the handover, as discussed with respect to FIGS. 4-12. For example, as described in 1232 of FIG. 12, the UE 1202 may receive the second positioning configuration from the network entity if the first positioning configuration is not valid based on the handover. Further, step 1406 may be performed by positioning component 198.

At 1408, the UE may transmit a positioning error message if the first positioning configuration is not valid based on the handover, as discussed with respect to FIGS. 4-12. For example, as described in 1240 of FIG. 12, the UE 1202 may transmit a positioning error message if the first positioning configuration is not valid based on the handover. Further, step 1408 may be performed by positioning component 198.

At 1410, the UE may switch to a second positioning configuration if the first positioning configuration is not valid based on the handover or maintain the first positioning configuration if the first positioning configuration is valid based on the handover, as discussed with respect to FIGS. 4-12. For example, as described in 1250 of FIG. 12, the UE 1202 may switch to a second positioning configuration if the first positioning configuration is not valid based on the handover or maintain the first positioning configuration if the first positioning configuration is valid based on the handover. Further, step 1410 may be performed by positioning component 198. The second positioning configuration may be provided to the second relay UE if the first positioning configuration is not valid based on the handover.

At 1412, the UE may adjust a measurement period for the positioning session after switching to the second positioning configuration; or restart the measurement period for the positioning session after maintaining the first positioning configuration, as discussed with respect to FIGS. 4-12. For example, as described in 1260 of FIG. 12, the UE 1202 may adjust a measurement period for the positioning session after switching to the second positioning configuration; or restart the measurement period for the positioning session after maintaining the first positioning configuration. Further, step 1412 may be performed by positioning component 198.

At 1414, the UE may perform at least one positioning measurement for the positioning session via the first relay UE if the first positioning configuration is valid based on the handover; and transmit positioning measurement data for the positioning session via the second relay UE if the first positioning configuration is valid based on the handover, where the positioning measurement data is based on the at least one positioning measurement for the positioning session via the first relay UE, as discussed with respect to FIGS. 4-12. For example, as described in 1270 of FIG. 12, the UE 1202 may perform at least one positioning measurement for the positioning session via the first relay UE if the first positioning configuration is valid based on the handover; and transmit positioning measurement data for the positioning session via the second relay UE if the first positioning configuration is valid based on the handover, where the positioning measurement data is based on the at least one positioning measurement for the positioning session via the first relay UE. Further, step 1414 may be performed by positioning component 198. In some aspects, performing the at least one positioning measurement may include at least one of: performing a set of round trip time (RTT) measurements or transmitting at least one positioning reference signal (PRS) transmission. The positioning measurement data may include at least one of a measurement report or location information for the first UE.

In some aspects, the handover from the first relay UE to the second relay UE may be associated with at least one handover distance threshold, such that the handover is executed if a distance between the first UE and the first relay UE is greater than the at least one handover distance threshold, where the at least one handover distance threshold includes a threshold bias distance. The at least one handover distance threshold may include a minimum distance threshold and a maximum distance threshold, where the threshold bias distance is at least one of: (i) greater than the minimum distance threshold, (ii) less than the maximum distance threshold, or (iii) greater than the minimum distance threshold and less than the maximum distance threshold. The handover from the first relay UE to the second relay UE may be associated with a notification message from the first relay UE to the first UE, where the first UE initiates the handover if the first UE is in a radio resource control (RRC) idle state or an RRC inactive state, and where the first UE initiates a connection re-establishment if the first UE is in an RRC connected state. The second positioning configuration may be associated with the positioning session between the first UE and the network entity via the second relay UE. The positioning session may be a sidelink (SL) positioning session, where the handover from the first relay UE to the second relay UE is a SL handover, where the first UE is a first remote UE, and where the network entity is a transmission-reception point (TRP) or a location management function (LMF).

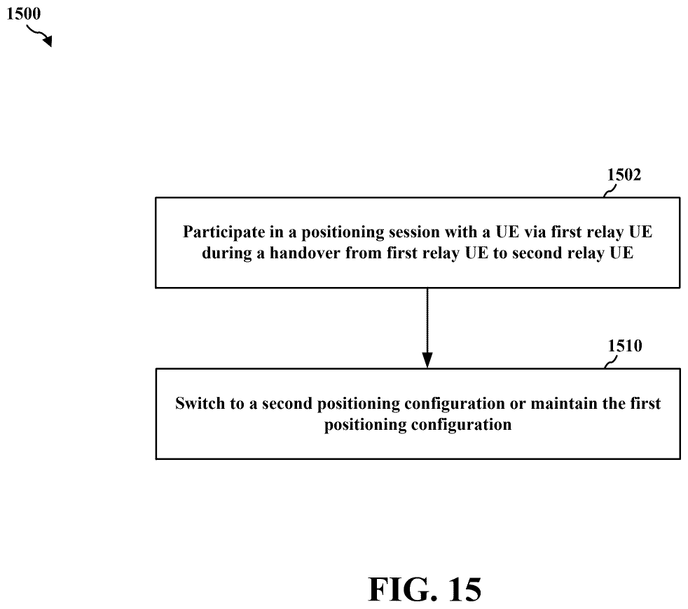

FIG. 15 is a flowchart 1500 of a method of wireless communication. The method may be performed by a network entity (e.g., the base station 102; network entity 1204; network entity 1802; the network entity 1960). The methods described herein may provide a number of benefits, such as improving resource utilization and/or power savings.

At 1502, the network entity may participate in a positioning session with a first user equipment (UE) via a first relay UE during a handover from the first relay UE to a second relay UE, where the positioning session with the first UE via the first relay UE is associated with a first positioning configuration, as discussed with respect to FIGS. 4-12. For example, as described in 1212 of FIG. 12, the network entity 1204 may participate in a positioning session with a first user equipment (UE) via a first relay UE during a handover from the first relay UE to a second relay UE, where the positioning session with the first UE via the first relay UE is associated with a first positioning configuration. Further, step 1502 may be performed by positioning component 199. The first positioning configuration may be associated with a first radio resource control (RRC) configuration message, and where the second positioning configuration is associated with a second RRC configuration message different from the first RRC configuration message.

At 1510, the network entity may switch to a second positioning configuration if the first positioning configuration is not valid based on the handover or maintaining the first positioning configuration if the first positioning configuration is valid based on the handover, as discussed with respect to FIGS. 4-12. For example, as described in 1252 of FIG. 12, the network entity 1204 may switch to a second positioning configuration if the first positioning configuration is not valid based on the handover or maintaining the first positioning configuration if the first positioning configuration is valid based on the handover. Further, step 1510 may be performed by positioning component 199. The second positioning configuration may be provided to the second relay UE if the first positioning configuration is not valid based on the handover. In some aspects, the handover from the first relay UE to the second relay UE may be associated with at least one handover distance threshold, such that the handover is executed if a distance between the first UE and the first relay UE is greater than the at least one handover distance threshold, where the at least one handover distance threshold includes a threshold bias distance. The at least one handover distance threshold may include a minimum distance threshold and a maximum distance threshold, where the threshold bias distance is at least one of: (i) greater than the minimum distance threshold, (ii) less than the maximum distance threshold, or (iii) greater than the minimum distance threshold and less than the maximum distance threshold. The handover from the first relay UE to the second relay UE may be associated with a notification message from the first relay UE to the first UE, where the first UE initiates the handover if the first UE is in a radio resource control (RRC) idle state or an RRC inactive state, and where the first UE initiates a connection re-establishment if the first UE is in an RRC connected state. The second positioning configuration may be associated with the positioning session between the first UE and the network entity via the second relay UE. The positioning session may be a sidelink (SL) positioning session, where the handover from the first relay UE to the second relay UE is a SL handover, where the first UE is a first remote UE, and where the network entity is a transmission-reception point (TRP) or a location management function (LMF).

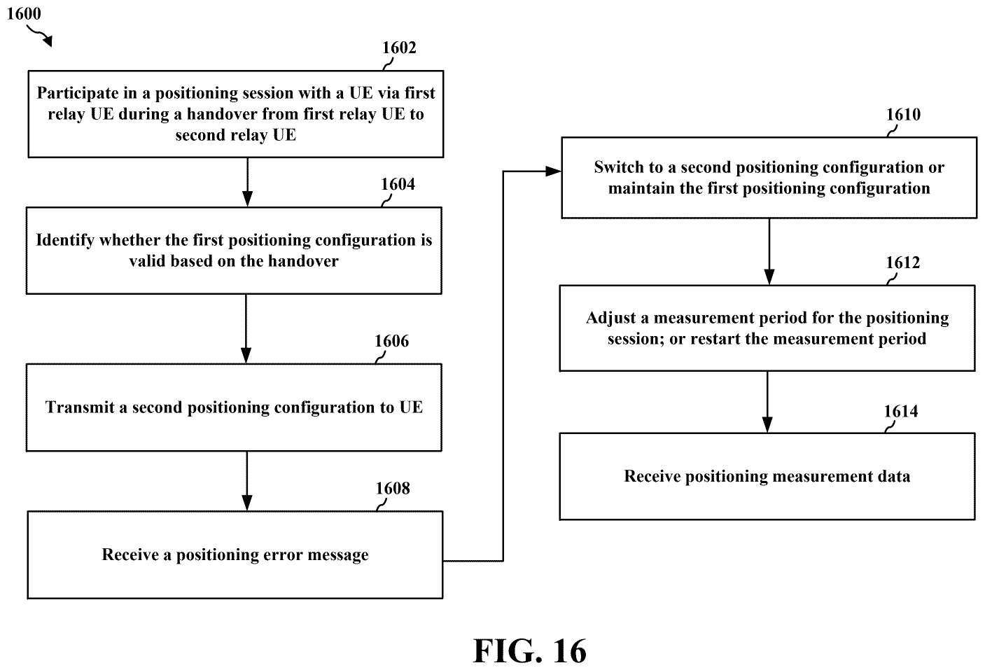

FIG. 16 is a flowchart 1600 of a method of wireless communication. The method may be performed by a network entity (e.g., the base station 102; network entity 1204; network entity 1802; the network entity 1960). The methods described herein may provide a number of benefits, such as improving resource utilization and/or power savings.

At 1602, the network entity may participate in a positioning session with a first user equipment (UE) via a first relay UE during a handover from the first relay UE to a second relay UE, where the positioning session with the first UE via the first relay UE is associated with a first positioning configuration, as discussed with respect to FIGS. 4-12. For example, as described in 1212 of FIG. 12, the network entity 1204 may participate in a positioning session with a first user equipment (UE) via a first relay UE during a handover from the first relay UE to a second relay UE, where the positioning session with the first UE via the first relay UE is associated with a first positioning configuration. Further, step 1602 may be performed by positioning component 199. The first positioning configuration may be associated with a first radio resource control (RRC) configuration message, and where the second positioning configuration is associated with a second RRC configuration message different from the first RRC configuration message.

At 1604, the network entity may identify whether the first positioning configuration is valid based on the handover from the first relay UE to the second relay UE, as discussed with respect to FIGS. 4-12. For example, as described in 1222 of FIG. 12, the network entity 1204 may identify whether the first positioning configuration is valid based on the handover from the first relay UE to the second relay UE. Further, step 1604 may be performed by positioning component 199.

At 1606, the network entity may transmit the second positioning configuration for the first UE if the first positioning configuration is not valid based on the handover, as discussed with respect to FIGS. 4-12. For example, as described in 1230 of FIG. 12, the network entity 1204 may transmit the second positioning configuration for the first UE if the first positioning configuration is not valid based on the handover. Further, step 1606 may be performed by positioning component 199.

At 1608, the network entity may receive a positioning error message if the first positioning configuration is not valid based on the handover, as discussed with respect to FIGS. 4-12. For example, as described in 1242 of FIG. 12, the network entity 1204 may receive a positioning error message if the first positioning configuration is not valid based on the handover. Further, step 1608 may be performed by positioning component 199.

At 1610, the network entity may switch to a second positioning configuration if the first positioning configuration is not valid based on the handover or maintaining the first positioning configuration if the first positioning configuration is valid based on the handover, as discussed with respect to FIGS. 4-12. For example, as described in 1252 of FIG. 12, the network entity 1204 may switch to a second positioning configuration if the first positioning configuration is not valid based on the handover or maintaining the first positioning configuration if the first positioning configuration is valid based on the handover. Further, step 1610 may be performed by positioning component 199. The second positioning configuration may be provided to the second relay UE if the first positioning configuration is not valid based on the handover.

At 1612, the network entity may adjust a measurement period for the positioning session after switching to the second positioning configuration; or restart the measurement period for the positioning session after maintaining the first positioning configuration, as discussed with respect to FIGS. 4-12. For example, as described in 1262 of FIG. 12, the network entity 1204 may adjust a measurement period for the positioning session after switching to the second positioning configuration; or restart the measurement period for the positioning session after maintaining the first positioning configuration. Further, step 1612 may be performed by positioning component 199.

At 1614, the network entity may receive positioning measurement data for the positioning session via the second relay UE if the first positioning configuration is valid based on the handover, where the positioning measurement data is based on at least one positioning measurement for the positioning session via the first relay UE, as discussed with respect to FIGS. 4-12. For example, as described in 1272 of FIG. 12, the network entity 1204 may receive positioning measurement data for the positioning session via the second relay UE if the first positioning configuration is valid based on the handover, where the positioning measurement data is based on at least one positioning measurement for the positioning session via the first relay UE. Further, step 1614 may be performed by positioning component 199. The at least one positioning measurement may be associated with at least one of a set of round trip time (RTT) measurements or a positioning reference signal (PRS) transmission. The positioning measurement data may include at least one of a measurement report or location information for the first UE.

In some aspects, the handover from the first relay UE to the second relay UE may be associated with at least one handover distance threshold, such that the handover is executed if a distance between the first UE and the first relay UE is greater than the at least one handover distance threshold, where the at least one handover distance threshold includes a threshold bias distance. The at least one handover distance threshold may include a minimum distance threshold and a maximum distance threshold, where the threshold bias distance is at least one of: (i) greater than the minimum distance threshold, (ii) less than the maximum distance threshold, or (iii) greater than the minimum distance threshold and less than the maximum distance threshold. The handover from the first relay UE to the second relay UE may be associated with a notification message from the first relay UE to the first UE, where the first UE initiates the handover if the first UE is in a radio resource control (RRC) idle state or an RRC inactive state, and where the first UE initiates a connection re-establishment if the first UE is in an RRC connected state. The second positioning configuration may be associated with the positioning session between the first UE and the network entity via the second relay UE. The positioning session may be a sidelink (SL) positioning session, where the handover from the first relay UE to the second relay UE is a SL handover, where the first UE is a first remote UE, and where the network entity is a transmission-reception point (TRP) or a location management function (LMF).

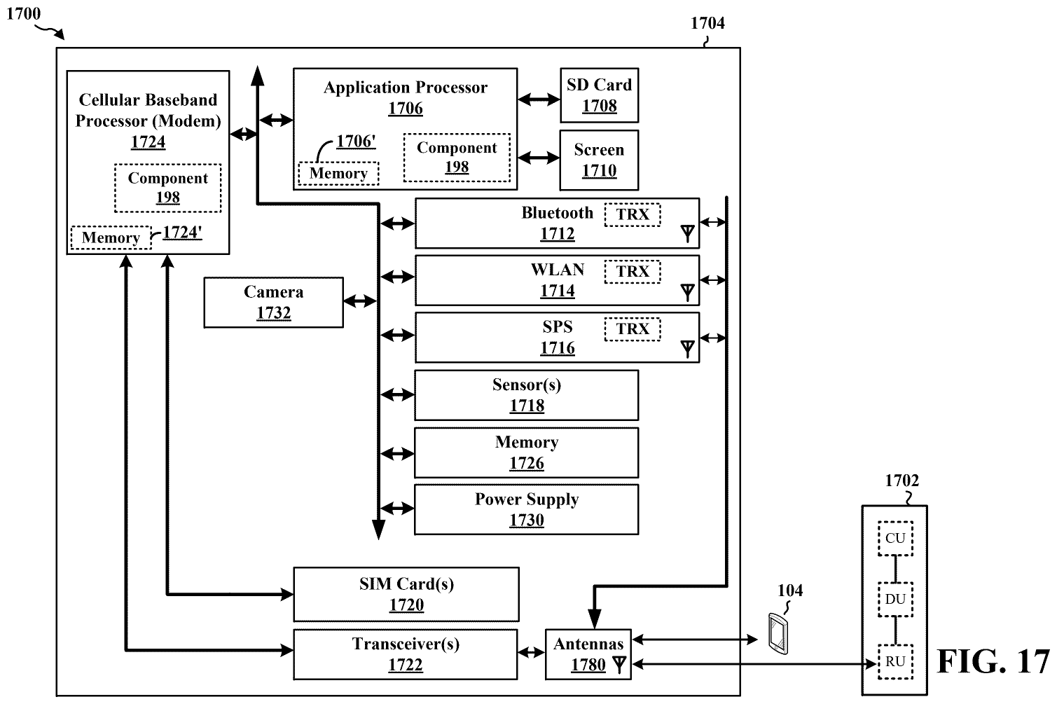

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial management unit (IMU), gyroscope, and/or accelerometer(s), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see 350 of FIG. 3) and include the additional modules of the apparatus 1704.

As discussed supra, the positioning component 198 may be configured to participate in a positioning session with a network entity via a first relay UE during a handover from the first relay UE to a second relay UE, where the positioning session with the network entity via the first relay UE is associated with a first positioning configuration. The positioning component 198 may also be configured to switch to a second positioning configuration if the first positioning configuration is not valid based on the handover or maintaining the first positioning configuration if the first positioning configuration is valid based on the handover. The positioning component 198 may also be configured to identify whether the first positioning configuration is valid based on the handover from the first relay UE to the second relay UE. The positioning component 198 may also be configured to transmit a positioning error message if the first positioning configuration is not valid based on the handover. The positioning component 198 may also be configured to receive the second positioning configuration from the network entity if the first positioning configuration is not valid based on the handover. The positioning component 198 may also be configured to adjust a measurement period for the positioning session after switching to the second positioning configuration; or restart the measurement period for the positioning session after maintaining the first positioning configuration. The positioning component 198 may also be configured to perform at least one positioning measurement for the positioning session via the first relay UE if the first positioning configuration is valid based on the handover; and transmit positioning measurement data for the positioning session via the second relay UE if the first positioning configuration is valid based on the handover, where the positioning measurement data is based on the at least one positioning measurement for the positioning session via the first relay UE.

The positioning component 198 may be within the cellular baseband processor 1724, the application processor 1706, or both the cellular baseband processor 1724 and the application processor 1706. The positioning component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, includes means for participating in a positioning session with a network entity via a first relay UE during a handover from the first relay UE to a second relay UE, where the positioning session with the network entity via the first relay UE is associated with a first positioning configuration. The apparatus 1704 may also include means for switching to a second positioning configuration if the first positioning configuration is not valid based on the handover or maintaining the first positioning configuration if the first positioning configuration is valid based on the handover. The apparatus 1704 may also include means for identifying whether the first positioning configuration is valid based on the handover from the first relay UE to the second relay UE. The apparatus 1704 may also include means for transmitting a positioning error message if the first positioning configuration is not valid based on the handover. The apparatus 1704 may also include means for receiving the second positioning configuration from the network entity if the first positioning configuration is not valid based on the handover. The apparatus 1704 may also include means for adjusting a measurement period for the positioning session after switching to the second positioning configuration; or means for restart the measurement period for the positioning session after maintaining the first positioning configuration. The apparatus 1704 may also include means for performing at least one positioning measurement for the positioning session via the first relay UE if the first positioning configuration is valid based on the handover; and means for transmitting positioning measurement data for the positioning session via the second relay UE if the first positioning configuration is valid based on the handover, where the positioning measurement data is based on the at least one positioning measurement for the positioning session via the first relay UE. The means may be the positioning component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

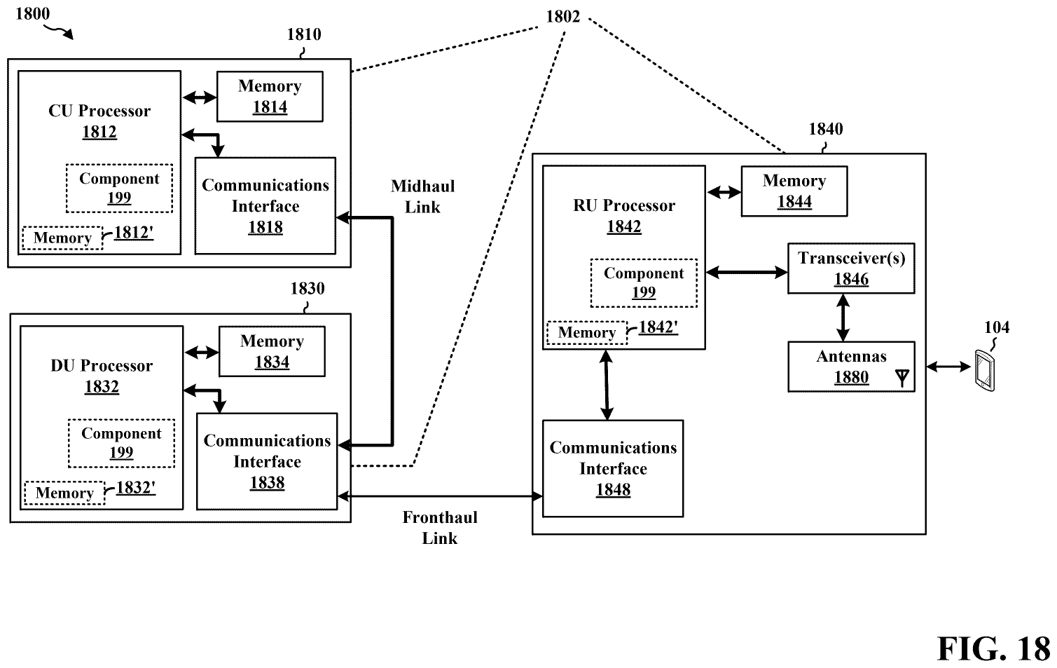

FIG. 18 is a diagram 1800 illustrating an example of a hardware implementation for a network entity 1802. The network entity 1802 may be a base station (BS), a component of a BS, or may implement BS functionality. The network entity 1802 may include at least one of a CU 1810, a DU 1830, or an RU 1840. For example, depending on the layer functionality handled by the positioning component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the positioning component 199 may be configured to participate in a positioning session with a first user equipment (UE) via a first relay UE during a handover from the first relay UE to a second relay UE, where the positioning session with the first UE via the first relay UE is associated with a first positioning configuration. The positioning component 199 may also be configured to switch to a second positioning configuration if the first positioning configuration is not valid based on the handover or maintaining the first positioning configuration if the first positioning configuration is valid based on the handover. The positioning component 199 may also be configured to identify whether the first positioning configuration is valid based on the handover from the first relay UE to the second relay UE. The positioning component 199 may also be configured to transmit the second positioning configuration for the first UE if the first positioning configuration is not valid based on the handover. The positioning component 199 may also be configured to receive a positioning error message if the first positioning configuration is not valid based on the handover. The positioning component 199 may also be configured to adjust a measurement period for the positioning session after switching to the second positioning configuration; or restart the measurement period for the positioning session after maintaining the first positioning configuration. The positioning component 199 may also be configured to receive positioning measurement data for the positioning session via the second relay UE if the first positioning configuration is valid based on the handover, where the positioning measurement data is based on at least one positioning measurement for the positioning session via the first relay UE. The positioning component 199 may be within one or more processors of one or more of the CU 1810, DU 1830, and the RU 1840. The positioning component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 includes means for participating in a positioning session with a first user equipment (UE) via a first relay UE during a handover from the first relay UE to a second relay UE, where the positioning session with the first UE via the first relay UE is associated with a first positioning configuration. The network entity 1802 may also include means for switching to a second positioning configuration if the first positioning configuration is not valid based on the handover or maintaining the first positioning configuration if the first positioning configuration is valid based on the handover. The network entity 1802 may also include means for identifying whether the first positioning configuration is valid based on the handover from the first relay UE to the second relay UE. The network entity 1802 may also include means for transmitting the second positioning configuration for the first UE if the first positioning configuration is not valid based on the handover. The network entity 1802 may also include means for receiving a positioning error message if the first positioning configuration is not valid based on the handover. The network entity 1802 may also include means for adjusting a measurement period for the positioning session after switching to the second positioning configuration; or means for restarting the measurement period for the positioning session after maintaining the first positioning configuration. The network entity 1802 may also include means for receiving positioning measurement data for the positioning session via the second relay UE if the first positioning configuration is valid based on the handover, where the positioning measurement data is based on at least one positioning measurement for the positioning session via the first relay UE. The means may be the positioning component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

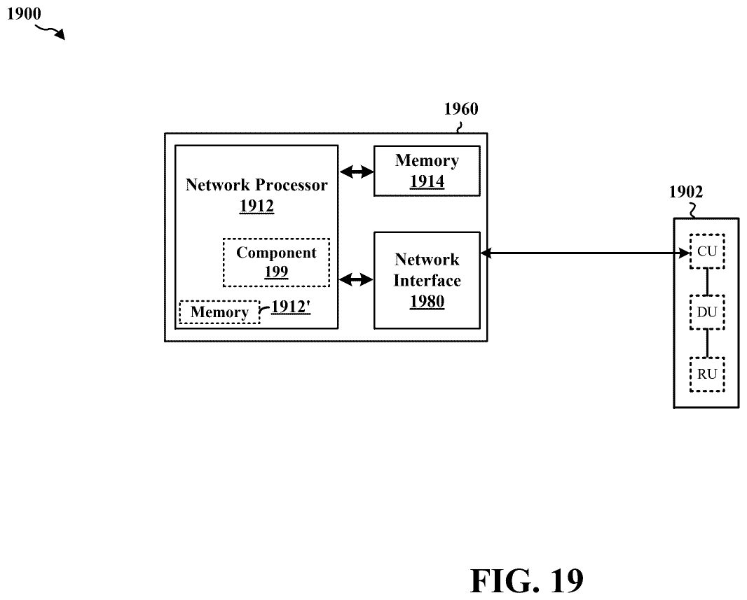

FIG. 19 is a diagram 1900 illustrating an example of a hardware implementation for a network entity 1960. In one example, the network entity 1960 may be within the core network 120. The network entity 1960 may include a network processor 1912. The network processor 1912 may include on-chip memory 1912′. In some aspects, the network entity 1960 may further include additional memory modules 1914. The network entity 1960 communicates via the network interface 1980 directly (e.g., backhaul link) or indirectly (e.g., through a RIC) with the CU 1902. The on-chip memory 1912′ and the additional memory modules 1914 may each be considered a computer-readable medium/memory. Each computer-readable medium/memory may be non-transitory. The processor 1912 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the positioning component 199 is configured to participate in a positioning session with a first user equipment (UE) via a first relay UE during a handover from the first relay UE to a second relay UE, where the positioning session with the first UE via the first relay UE is associated with a first positioning configuration. The positioning component 199 may also be configured to switch to a second positioning configuration if the first positioning configuration is not valid based on the handover or maintaining the first positioning configuration if the first positioning configuration is valid based on the handover. The positioning component 199 may also be configured to identify whether the first positioning configuration is valid based on the handover from the first relay UE to the second relay UE. The positioning component 199 may also be configured to transmit the second positioning configuration for the first UE if the first positioning configuration is not valid based on the handover. The positioning component 199 may also be configured to receive a positioning error message if the first positioning configuration is not valid based on the handover. The positioning component 199 may also be configured to adjust a measurement period for the positioning session after switching to the second positioning configuration; or restart the measurement period for the positioning session after maintaining the first positioning configuration. The positioning component 199 may also be configured to receive positioning measurement data for the positioning session via the second relay UE if the first positioning configuration is valid based on the handover, where the positioning measurement data is based on at least one positioning measurement for the positioning session via the first relay UE. The positioning component 199 may be within the processor 1912. The positioning component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1960 may include a variety of components configured for various functions. In one configuration, the network entity 1960 includes means for participating in a positioning session with a first user equipment (UE) via a first relay UE during a handover from the first relay UE to a second relay UE, where the positioning session with the first UE via the first relay UE is associated with a first positioning configuration. The network entity 1960 may also include means for switching to a second positioning configuration if the first positioning configuration is not valid based on the handover or maintaining the first positioning configuration if the first positioning configuration is valid based on the handover. The network entity 1960 may also include means for identifying whether the first positioning configuration is valid based on the handover from the first relay UE to the second relay UE. The network entity 1960 may also include means for transmitting the second positioning configuration for the first UE if the first positioning configuration is not valid based on the handover. The network entity 1960 may also include means for receiving a positioning error message if the first positioning configuration is not valid based on the handover. The network entity 1960 may also include means for adjusting a measurement period for the positioning session after switching to the second positioning configuration; or means for restarting the measurement period for the positioning session after maintaining the first positioning configuration. The network entity 1960 may also include means for receiving positioning measurement data for the positioning session via the second relay UE if the first positioning configuration is valid based on the handover, where the positioning measurement data is based on at least one positioning measurement for the positioning session via the first relay UE. The means may be positioning component 199 of the network entity 1960 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a first user equipment (UE) or a wireless device, including a memory and at least one processor coupled to the memory and, based at least in part on information stored in the memory, the at least one processor is configured to: participate in a positioning session with a network entity via a first relay UE during a handover from the first relay UE to a second relay UE, where the positioning session with the network entity via the first relay UE is associated with a first positioning configuration; and switch to a second positioning configuration if the first positioning configuration is not valid based on the handover or maintaining the first positioning configuration if the first positioning configuration is valid based on the handover.

Aspect 2 is the apparatus of aspect 1, where the at least one processor is further configured to: identify whether the first positioning configuration is valid based on the handover from the first relay UE to the second relay UE; and transmit a positioning error message if the first positioning configuration is not valid based on the handover.

Aspect 3 is the apparatus of any of aspects 1 and 2, where the at least one processor is further configured to: receive the second positioning configuration from the network entity if the first positioning configuration is not valid based on the handover.

Aspect 4 is the apparatus of any of aspects 1 to 3, where the first positioning configuration is associated with a first radio resource control (RRC) configuration message, and where the second positioning configuration is associated with a second RRC configuration message different from the first RRC configuration message.

Aspect 5 is the apparatus of any of aspects 1 to 4, where the at least one processor is further configured to: adjust a measurement period for the positioning session after switching to the second positioning configuration; or restart the measurement period for the positioning session after maintaining the first positioning configuration.

Aspect 6 is the apparatus of any of aspects 1 to 5, where the at least one processor is further configured to: perform at least one positioning measurement for the positioning session via the first relay UE if the first positioning configuration is valid based on the handover; and transmit positioning measurement data for the positioning session via the second relay UE if the first positioning configuration is valid based on the handover, where the positioning measurement data is based on the at least one positioning measurement for the positioning session via the first relay UE.

Aspect 7 is the apparatus of any of aspects 1 to 6, where to perform the at least one positioning measurement, the at least one processor is configured to at least one of: perform a set of round trip time (RTT) measurements or transmit at least one positioning reference signal (PRS) transmission.

Aspect 8 is the apparatus of any of aspects 1 to 7, where the positioning measurement data includes at least one of a measurement report or location information for the first UE.

Aspect 9 is the apparatus of any of aspects 1 to 8, where the second positioning configuration is provided to the second relay UE if the first positioning configuration is not valid based on the handover.

Aspect 10 is the apparatus of any of aspects 1 to 9, where the handover from the first relay UE to the second relay UE is associated with at least one handover distance threshold, such that the handover is executed if a distance between the first UE and the first relay UE is greater than the at least one handover distance threshold, where the at least one handover distance threshold includes a threshold bias distance.

Aspect 11 is the apparatus of any of aspects 1 to 10, where the at least one handover distance threshold includes a minimum distance threshold and a maximum distance threshold, where the threshold bias distance is at least one of: (i) greater than the minimum distance threshold, (ii) less than the maximum distance threshold, or (iii) greater than the minimum distance threshold and less than the maximum distance threshold.

Aspect 12 is the apparatus of any of aspects 1 to 11, where the handover from the first relay UE to the second relay UE is associated with a notification message from the first relay UE to the first UE, where the first UE initiates the handover if the first UE is in a radio resource control (RRC) idle state or an RRC inactive state, and where the first UE initiates a connection re-establishment if the first UE is in an RRC connected state.

Aspect 13 is the apparatus of any of aspects 1 to 12, where the second positioning configuration is associated with the positioning session between the first UE and the network entity via the second relay UE.

Aspect 14 is the apparatus of any of aspects 1 to 13, where the positioning session is a sidelink (SL) positioning session, where the handover from the first relay UE to the second relay UE is a SL handover, where the first UE is a first remote UE, and where the network entity is a transmission-reception point (TRP) or a location management function (LMF).

Aspect 15 is an apparatus for wireless communication at a network entity (e.g., a TRP or an LMF), including a memory and at least one processor coupled to the memory and, based at least in part on information stored in the memory, the at least one processor is configured to: participate in a positioning session with a first user equipment (UE) via a first relay UE during a handover from the first relay UE to a second relay UE, where the positioning session with the first UE via the first relay UE is associated with a first positioning configuration; and switch to a second positioning configuration if the first positioning configuration is not valid based on the handover or maintaining the first positioning configuration if the first positioning configuration is valid based on the handover.

Aspect 16 is the apparatus of aspect 15, where the at least one processor is further configured to: identify whether the first positioning configuration is valid based on the handover from the first relay UE to the second relay UE; and transmit the second positioning configuration for the first UE if the first positioning configuration is not valid based on the handover.

Aspect 17 is the apparatus of any of aspects 15 to 16, where the at least one processor is further configured to: receive a positioning error message if the first positioning configuration is not valid based on the handover.

Aspect 18 is the apparatus of any of aspects 15 to 17, where the first positioning configuration is associated with a first radio resource control (RRC) configuration message, and where the second positioning configuration is associated with a second RRC configuration message different from the first RRC configuration message.

Aspect 19 is the apparatus of any of aspects 15 to 18, where the at least one processor is further configured to: adjust a measurement period for the positioning session after switching to the second positioning configuration; or restart the measurement period for the positioning session after maintaining the first positioning configuration.

Aspect 20 is the apparatus of any of aspects 15 to 19, where the at least one processor is further configured to: receive positioning measurement data for the positioning session via the second relay UE if the first positioning configuration is valid based on the handover, where the positioning measurement data is based on at least one positioning measurement for the positioning session via the first relay UE.

Aspect 21 is the apparatus of any of aspects 15 to 20, where the at least one positioning measurement is associated with at least one of a set of round trip time (RTT) measurements or a positioning reference signal (PRS) transmission.

Aspect 22 is the apparatus of any of aspects 15 to 21, where the positioning measurement data includes at least one of a measurement report or location information for the first UE.

Aspect 23 is the apparatus of any of aspects 15 to 22, where the second positioning configuration is provided to the second relay UE if the first positioning configuration is not valid based on the handover.

Aspect 24 is an apparatus of any of aspects 15 to 23, where the handover from the first relay UE to the second relay UE is associated with at least one handover distance threshold, such that the handover is executed if a distance between the first UE and the first relay UE is greater than the at least one handover distance threshold, where the at least one handover distance threshold includes a threshold bias distance.

Aspect 25 is the apparatus of any of aspects 15 to 24, where the at least one handover distance threshold includes a minimum distance threshold and a maximum distance threshold, where the threshold bias distance is at least one of: (i) greater than the minimum distance threshold, (ii) less than the maximum distance threshold, or (iii) greater than the minimum distance threshold and less than the maximum distance threshold.

Aspect 26 is the apparatus of any of aspects 15 to 25, where the handover from the first relay UE to the second relay UE is associated with a notification message from the first relay UE to the first UE, where the first UE initiates the handover if the first UE is in a radio resource control (RRC) idle state or an RRC inactive state, and where the first UE initiates a connection re-establishment if the first UE is in an RRC connected state.

Aspect 27 is the apparatus of any of aspects 15 to 26, where the second positioning configuration is associated with the positioning session between the first UE and the network entity via the second relay UE.

Aspect 28 is the apparatus of any of aspects 15 to 27, where the positioning session is a sidelink (SL) positioning session, where the handover from the first relay UE to the second relay UE is a SL handover, where the first UE is a first remote UE, and where the network entity is a transmission-reception point (TRP) or a location management function (LMF).

Aspect 29 is the apparatus of any of aspects 1 to 28, where the apparatus is a wireless communication device, further including at least one of an antenna or a transceiver coupled to the at least one processor.

Aspect 30 is a method of wireless communication for implementing any of aspects 1 to 29.

Aspect 31 is an apparatus for wireless communication including means for implementing any of aspects 1 to 29.

Aspect 32 is a computer-readable medium (e.g., a non-transitory computer-readable medium) storing computer executable code, the code when executed by at least one processor causes the at least one processor to implement any of aspects 1 to 29.

What is claimed is:

1. An apparatus for wireless communication at a first user equipment (UE), comprising:
a memory; and
at least one processor coupled to the memory and, based at least in part on information stored in the memory, the at least one processor is configured to:
participate in a positioning session with a network entity via a first relay UE during a handover from the first relay UE to a second relay UE, wherein the positioning session with the network entity via the first relay UE is associated with a first positioning configuration; and
switch to a second positioning configuration if the first positioning configuration is not valid based on the handover or maintaining the first positioning configuration if the first positioning configuration is valid based on the handover.

2. The apparatus of claim 1, wherein the at least one processor is further configured to:
identify whether the first positioning configuration is valid based on the handover from the first relay UE to the second relay UE; and
transmit a positioning error message if the first positioning configuration is not valid based on the handover.

3. The apparatus of claim 1, wherein the at least one processor is further configured to:
receive the second positioning configuration from the network entity if the first positioning configuration is not valid based on the handover.

4. The apparatus of claim 1, wherein the first positioning configuration is associated with a first radio resource control (RRC) configuration message, and wherein the second positioning configuration is associated with a second RRC configuration message different from the first RRC configuration message.

5. The apparatus of claim 1, wherein the at least one processor is further configured to:
adjust a measurement period for the positioning session after switching to the second positioning configuration; or
restart the measurement period for the positioning session after maintaining the first positioning configuration.

6. The apparatus of claim 1, wherein the at least one processor is further configured to:
perform at least one positioning measurement for the positioning session via the first relay UE if the first positioning configuration is valid based on the handover; and
transmit positioning measurement data for the positioning session via the second relay UE if the first positioning configuration is valid based on the handover, wherein the positioning measurement data is based on the at least one positioning measurement for the positioning session via the first relay UE.

7. The apparatus of claim 6, wherein to perform the at least one positioning measurement, the at least one processor is configured to at least one of: perform a set of round trip time (RTT) measurements or transmit at least one positioning reference signal (PRS) transmission.

8. The apparatus of claim 6, wherein the positioning measurement data includes at least one of a measurement report or location information for the first UE.

9. The apparatus of claim 1, wherein the second positioning configuration is provided to the second relay UE if the first positioning configuration is not valid based on the handover.

10. The apparatus of claim 1, wherein the handover from the first relay UE to the second relay UE is associated with at least one handover distance threshold, such that the handover is executed if a distance between the first UE and the first relay UE is greater than the at least one handover distance threshold, wherein the at least one handover distance threshold includes a threshold bias distance.

11. The apparatus of claim 10, wherein the at least one handover distance threshold includes a minimum distance threshold and a maximum distance threshold, wherein the threshold bias distance is at least one of: (i) greater than the minimum distance threshold, (ii) less than the maximum distance threshold, or (iii) greater than the minimum distance threshold and less than the maximum distance threshold.

12. The apparatus of claim 1, wherein the handover from the first relay UE to the second relay UE is associated with a notification message from the first relay UE to the first UE, wherein the first UE initiates the handover if the first UE is in a radio resource control (RRC) idle state or an RRC inactive state, and wherein the first UE initiates a connection re-establishment if the first UE is in an RRC connected state.

13. The apparatus of claim 1, wherein the second positioning configuration is associated with the positioning session between the first UE and the network entity via the second relay UE.

14. The apparatus of claim 1, wherein the positioning session is a sidelink (SL) positioning session, wherein the handover from the first relay UE to the second relay UE is a SL handover, wherein the first UE is a first remote UE, and wherein the network entity is a transmission-reception point (TRP) or a location management function (LMF).

15. An apparatus for wireless communication at a network entity, comprising:
a memory; and
at least one processor coupled to the memory and, based at least in part on information stored in the memory, the at least one processor is configured to:
participate in a positioning session with a first user equipment (UE) via a first relay UE during a handover from the first relay UE to a second relay UE, wherein the positioning session with the first UE via the first relay UE is associated with a first positioning configuration; and
switch to a second positioning configuration if the first positioning configuration is not valid based on the handover or maintaining the first positioning configuration if the first positioning configuration is valid based on the handover.

16. The apparatus of claim 15, wherein the at least one processor is further configured to:
identify whether the first positioning configuration is valid based on the handover from the first relay UE to the second relay UE; and
transmit the second positioning configuration for the first UE if the first positioning configuration is not valid based on the handover.

17. The apparatus of claim 15, wherein the at least one processor is further configured to:
receive a positioning error message if the first positioning configuration is not valid based on the handover.

18. The apparatus of claim 15, wherein the first positioning configuration is associated with a first radio resource control (RRC) configuration message, and wherein the second positioning configuration is associated with a second RRC configuration message different from the first RRC configuration message.

19. The apparatus of claim 15, wherein the at least one processor is further configured to:
adjust a measurement period for the positioning session after switching to the second positioning configuration; or
restart the measurement period for the positioning session after maintaining the first positioning configuration.

20. The apparatus of claim 15, wherein the at least one processor is further configured to:
receive positioning measurement data for the positioning session via the second relay UE if the first positioning configuration is valid based on the handover, wherein the positioning measurement data is based on at least one positioning measurement for the positioning session via the first relay UE.

21. The apparatus of claim 20, wherein the at least one positioning measurement is associated with at least one of a set of round trip time (RTT) measurements or a positioning reference signal (PRS) transmission.

22. The apparatus of claim 20, wherein the positioning measurement data includes at least one of a measurement report or location information for the first UE.

23. The apparatus of claim 15, wherein the second positioning configuration is provided to the second relay UE if the first positioning configuration is not valid based on the handover.

24. The apparatus of claim 15, wherein the handover from the first relay UE to the second relay UE is associated with at least one handover distance threshold, such that the handover is executed if a distance between the first UE and the first relay UE is greater than the at least one handover distance threshold, wherein the at least one handover distance threshold includes a threshold bias distance.

25. The apparatus of claim 24, wherein the at least one handover distance threshold includes a minimum distance threshold and a maximum distance threshold, wherein the threshold bias distance is at least one of: (i) greater than the minimum distance threshold, (ii) less than the maximum distance threshold, or (iii) greater than the minimum distance threshold and less than the maximum distance threshold.

26. The apparatus of claim 15, wherein the handover from the first relay UE to the second relay UE is associated with a notification message from the first relay UE to the first UE, wherein the first UE initiates the handover if the first UE is in a radio resource control (RRC) idle state or an RRC inactive state, and wherein the first UE initiates a connection re-establishment if the first UE is in an RRC connected state.

27. The apparatus of claim 15, wherein the second positioning configuration is associated with the positioning session between the first UE and the network entity via the second relay UE.

28. The apparatus of claim 15, wherein the positioning session is a sidelink (SL) positioning session, wherein the handover from the first relay UE to the second relay UE is a SL handover, wherein the first UE is a first remote UE, and wherein the network entity is a transmission-reception point (TRP) or a location management function (LMF).

29. A method of wireless communication at a first user equipment (UE), comprising:
participating in a positioning session with a network entity via a first relay UE during a handover from the first relay UE to a second relay UE, wherein the positioning session with the network entity via the first relay UE is associated with a first positioning configuration; and
switching to a second positioning configuration if the first positioning configuration is not valid based on the handover or maintaining the first positioning configuration if the first positioning configuration is valid based on the handover.

30. A method of wireless communication at a network entity, comprising:
participating in a positioning session with a first user equipment (UE) via a first relay UE during a handover from the first relay UE to a second relay UE, wherein the positioning session with the first UE via the first relay UE is associated with a first positioning configuration; and
switching to a second positioning configuration if the first positioning configuration is not valid based on the handover or maintaining the first positioning configuration if the first positioning configuration is valid based on the handover.
